(19) United States
(12) Patent Application Publication
(10) Pub. No.: US 2016/0281399 A1
(43) Pub. Date: Sep. 29, 2016

(54) OPENING ADJUSTING BLOCK, OPENING ADJUSTING DEVICE AND DOOR CHECKING MECHANISM FOR VEHICLE DOOR

(71) Applicant: AISIN SEIKI KABUSHIKI KAISHA, Kariya-shi (JP)

(72) Inventors: Tomokazu SEKI, Kariya-shi (JP); Shintaro SUZUKI, Kariya-shi (JP); Miho YARIMIZU, Kariya-shi (JP)

(73) Assignee: AISIN SEIKI KABUSHIKI KAISHA, Kariya-shi, Aichi-ken (JP)

(21) Appl. No.: 15/035,918

(22) PCT Filed: Nov. 12, 2014
(86) PCT No.: PCT/JP2014/005673

§ 371 Date: May 11, 2016

(30) Foreign Application Priority Data
Nov. 13, 2013 (JP) 2013-235061

(51) Int. Cl. E05C 17/20; E05C 17/22

(52) U.S. Cl. CPC E05C 17/203; E05C 17/22; E05Y 2900/531

(57) ABSTRACT

An opening adjusting device adjusting an opening of a door for a vehicle, the opening adjustment device being used at a door checking mechanism including a movement restriction portion configured to be fixed at the door for the vehicle, the door checking mechanism being provided with a check link including a first end portion being rotatably mounted on a vehicle body, the check link extending at an inside of the door for the vehicle, the check link being movable in a longitudinal direction of the check link relative to the movement restriction portion relatively, the door checking mechanism including a stopper portion being provided at a second end portion of the check link includes an opening adjusting block including a first portion and a second portion having a predetermined distance from the first portion in a moving direction of the check link, and the movement restriction portion.

### TECHNICAL FIELD

This invention relates to an opening adjusting block, an opening adjusting device and a door checking mechanism of a door for a vehicle.

### BACKGROUND ART

A door for a vehicle is generally connected to a vehicle body via a door hinge and is able to open in response to the movement of the door hinge. A door checking mechanism is provided at the door for the vehicle, and the door checking mechanism can retain the door at a fully-open position and at a half-open position.

However, regarding to the open position of the door, especially at the half-open position, the known door checking mechanism does not prevent the door from opening further. Thus, in a case where the door is half-open, and in a case where a user does not intend to open the door, the door comes to be open when a force in an opening direction is applied to the door. Accordingly, the door may come in contact with, for example, obstacles that are disposed at a lateral position of the vehicle.

Accordingly, a door checking mechanism is proposed as disclosed in Patent reference 1, the door checking mechanism that fixes a door at the open position by applying a force of constraint to a check arm when a door is in an opening operation.

### DOCUMENT OF PRIOR ART

### Patent Document

Patent document 1: Japanese Patent Application Publication 2007-39981

### OVERVIEW OF INVENTION

### Problem to be Solved by Invention

The present invention provides an opening adjusting block, an opening adjusting device and a door checking mechanism of a door for a vehicle that can set an opening of the door and that can prevent the door from opening further than an opening being set.

### Means for Solving Problem

According to an embodiment of the present invention, an opening adjusting device adjusting an opening of a door for a vehicle, the opening adjusting device being used at a door checking mechanism including a movement restriction portion configured to be fixed at the door for the vehicle, the door checking mechanism being provided with a check link including a first end portion being rotatably mounted on a vehicle body, the check link extending at an inside of the door for the vehicle, the check link being movable in a longitudinal direction of the check link relative to the movement restriction portion relatively, the door checking mechanism including a stopper portion being provided at a second end portion of the check link extending at the inside of the door for the vehicle, includes an opening adjusting block including a first portion and a second portion having a predetermined distance from the first portion in a moving direction of the check link, and the movement restriction portion. The movement restriction portion restricts the opening adjusting block from moving to the first end portion of the check link by coming in contact with the first portion. In a case where the movement restriction portion restricts the opening adjusting block from moving to the first end portion of the check link, the opening adjusting block restricts the check link from moving to the first end portion of the check link by a contact of the second portion with the stopper portion.

According to another embodiment of the present invention, a door checking mechanism includes a movement restriction portion configured to be fixed at a door for a vehicle, a check link including a first end portion being rotatably mounted on a vehicle body, the check link extending at an inside of the door for the vehicle, the check link being movable in a longitudinal direction of the check link relative to the movement restriction portion relatively, a stopper portion being provided at a second end portion of the check link extending at the inside of the door for the vehicle, and an opening adjusting block including a first portion and a second portion having a predetermined distance from the first portion in a moving direction of the check link. The movement restriction portion restricts the opening adjusting block from moving to the first end portion of the check link by coming in contact with the first portion. In a case where the movement restriction portion restricts the opening adjusting block from moving to the first end portion of the check link, the opening adjusting block restricts the check link from moving to the first end portion of the check link by having the second portion come in contact with the stopper portion.

According to still further embodiment of the present invention, an opening adjusting block adjusting an opening of a door for a vehicle, the opening adjusting block being used at a door checking mechanism including a movement restriction portion configured to be fixed at the door for the vehicle, the opening adjusting block being provided with a check link including a first end portion being rotatably mounted on a vehicle body, the check link extending at an inside of the door for the vehicle, the check link being movable in a longitudinal direction of the check link relative to the movement restriction portion relatively, the opening adjusting block including a stopper portion being provided at a second end portion of the check link, includes a first portion, and a second portion having a predetermined distance from the first portion in a moving direction of the check link. The movement restriction portion restricts the opening adjusting block from moving to the first end portion of the check link by coming in contact with the first portion. In a case where the movement restriction portion restricts the opening adjusting block from moving to the first end portion of the check link, the opening adjusting block restricts the check link from moving to the first end portion of the check link by having the second portion come in contact with the stopper portion.

According to still another aspect of the present invention, an opening adjusting block adjusting an opening of a door for a vehicle, the opening adjusting device being used at a door checking mechanism including a door check configured to be fixed at the door for the vehicle, the opening adjusting block being provided with a check link including a first end portion being rotatably mounted on a vehicle body, the check link extending at an inside of the door for the vehicle, the check link being movable in a longitudinal direction of the check link relative to the movement restriction portion relatively, the opening adjusting block including a stopper portion being provided at a second end portion of the check link extending at the inside of the door for the vehicle, includes a recess configured to contain the check link. In a case where the opening adjusting block is disposed between the door check and the stopper portion so as to contain the check link at the recess, the opening adjusting block restricts the check link from moving to the first end portion of the check link by coming in contact with the door check and the stopper portion.

According to the aforementioned constructions, an opening adjusting block, an opening adjusting device and a door checking mechanism of a door for a vehicle that are provided can set an opening of the door and can prevent the door from opening further than an opening being set.

Further characteristics of the present invention become apparent from an explanation of embodiments explained below, the explanation that is exemplarily shown with reference to the attached drawings.

### BRIEF DESCRIPTION OF DRAWINGS

FIG. 1 A view schematically illustrating a door for a vehicle, the door including a door checking mechanism;

FIG. 2A A view illustrating a movement of the door checking mechanism;

FIG. 2B A view illustrating another movement of the door checking mechanism;

FIG. 3A A view illustrating the door checking mechanism that is provided with an opening adjusting block according to a first embodiment of the present invention;

FIG. 3B A view illustrating the opening adjusting block according to the first embodiment of the present invention;

FIG. 3C A view illustrating the door checking mechanism that is provided with the opening adjusting block according to the first embodiment of the present invention;

FIG. 4A A view for explaining an adjusting method of an opening of the door using the opening adjusting block according to the first embodiment of the present invention;

FIG. 4B Another view for explaining the adjusting method of the opening of the door using the opening adjusting block according to the first embodiment of the present invention;

FIG. 4C Still another view for explaining the adjusting method of the opening of the door using the opening adjusting block according to the first embodiment of the present invention;

FIG. 4D Further view for explaining the adjusting method of the opening of the door using the opening adjusting block according to the first embodiment of the present invention;

FIG. 5A A view illustrating an opening adjustment dial according to the first embodiment of the present invention;

FIG. 5B A view illustrating another example of the opening adjustment dial according to the first embodiment of the present invention;

FIG. 5C A view illustrating still another example of the opening adjustment dial according to the first embodiment of the present invention;

FIG. 6 A block diagram illustrating, for example, a control portion of a modified example of the first embodiment of the present invention;

FIG. 7A A view illustrating a door checking mechanism including an opening adjusting block according to a second embodiment of the present invention;

FIG. 7B Another view illustrating the door checking mechanism including the opening adjusting block according to the second embodiment of the present invention;

FIG. 8 A block diagram illustrating, for example, a control portion of a modified example of the second embodiment of the present invention;

FIG. 9A A view illustrating a door checking mechanism including an opening adjusting device of a third embodiment of the present invention;

FIG. 9B A view illustrating a block case of the third embodiment of the present invention;

FIG. 9C A view illustrating an opening adjusting block according to the third embodiment of the present invention;

FIG. 9D A view illustrating a containment of the opening adjusting block to the block case according to the third embodiment of the present invention;

FIG. 9E A view illustrating an assembling of the opening adjusting device to a door checking mechanism according to the third embodiment of the present invention;

FIG. 10A A view for illustrating a door hinge mechanism according to a fourth embodiment of the present invention;

FIG. 10B Another view for illustrating the door hinge mechanism according to the fourth embodiment of the present invention;

FIG. 10C Still another view for illustrating the door hinge mechanism according to the fourth embodiment of the present invention;

FIG. 10D Further view for illustrating the door hinge mechanism according to the fourth embodiment of the present invention;

FIG. 11A A view illustrating an opening adjusting device including an opening adjusting block according to the fourth embodiment of the present invention;

FIG. 11B A view illustrating a housing according to the fourth embodiment of the present invention;

FIG. 11C A view illustrating the opening adjusting block according to the fourth embodiment of the present invention;

FIG. 12A A view for explaining the movement of the door hinge mechanism according to the fourth embodiment of the present invention;

FIG. 12B Another view for explaining the movement of the door hinge mechanism according to the fourth embodiment of the present invention;

FIG. 12C Still another view for explaining the movement of the door hinge mechanism according to the fourth embodiment of the present invention;

FIG. 13A A view for explaining the movement of a door using the door hinge mechanism according to the fourth embodiment of the present invention;

FIG. 13B Another view for explaining the movement of the door using the door hinge mechanism according to the fourth embodiment of the present invention;

FIG. 13C Still another view for explaining the movement of the door using the door hinge mechanism according to the fourth embodiment of the present invention;

FIG. 14 A view illustrating a modified example of the opening adjusting block according to the first embodiment of the present invention;

FIG. 15A A view illustrating a door checking mechanism including an opening adjusting block according to a fifth embodiment of the present invention;

FIG. 15B A view illustrating a housing of the door checking mechanism according to the fifth embodiment of the present invention;

FIG. 15C A view illustrating the opening adjusting block according to the fifth embodiment of the present invention;

FIG. 15D A view illustrating a positional restriction member of the door checking mechanism according to the fifth embodiment of the present invention;

FIG. 15E A view illustrating the door checking mechanism including the opening adjusting block according to the fifth embodiment of the present invention;

FIG. 16A A view for explaining an adjusting method of the opening of the door using the opening adjusting block according to the fifth embodiment of the present invention;

FIG. 16B Another view for explaining the adjusting method of the opening of the door using the opening adjusting block according to the fifth embodiment of the present invention;

FIG. 17A A view illustrating a door checking mechanism including an opening adjusting block according to a sixth embodiment of the present invention;

FIG. 17B A view illustrating the opening adjusting block according to the sixth embodiment of the present invention;

FIG. 18A A view for explaining an adjusting method of the opening of the door using the opening adjusting block according to the sixth embodiment of the present invention;

FIG. 18B A view for explaining an adjusting method of the opening of the door using the opening adjusting block according to the sixth embodiment of the present invention;

FIG. 19A A view illustrating a door checking mechanism including an opening adjusting block according to a seventh embodiment of the present invention;

FIG. 19B A view illustrating a housing of the door checking mechanism according to the seventh embodiment of the present invention;

FIG. 19C A view illustrating the opening adjusting block according to the seventh embodiment of the present invention;

FIG. 19D A view illustrating a positional restriction member of the door checking mechanism according to the seventh embodiment of the present invention;

FIG. 19E A view illustrating the door checking mechanism including the opening adjusting block according to the seventh embodiment of the present invention;

FIG. 20A A view for explaining an adjusting method of the opening of the door using the opening adjusting block according to the seventh embodiment of the present invention;

FIG. 20B Another view for explaining the adjusting method of the opening of the door using the opening adjusting block according to the seventh embodiment of the present invention;

FIG. 20C Still another view for explaining the adjusting method of the opening of the door using the opening adjusting block according to the seventh embodiment of the present invention;

FIG. 21A A cross sectional view taken along line 21A-21A in FIG. 20A;

FIG. 21B A cross sectional view taken along line 21B-21B in FIG. 20B;

FIG. 21C A cross sectional view taken along line 21C-21C in FIG. 20C;

FIG. 22 A view illustrating the movement of the door checking mechanism corresponding to the opening of the door that is restricted shown in FIGS. 21A through 21C;

FIG. 23A A view illustrating a modified example of the door checking mechanism using the opening adjusting block according to the seventh embodiment of the present invention; and

FIG. 23B A view illustrating a housing of the modified example of the door checking mechanism according to the seventh embodiment of the present invention.

### MODE FOR CARRYING OUT THE INVENTION

Hereinafter, exemplified embodiments for carrying out the present invention will be explained in detail with reference to the drawings. However, dimensions, materials, shapes and relative positions of components explained in the following embodiments are optional and can be changed in accordance with a structure of a device being applied with the present invention or with various conditions. In the drawings, same reference numerals are used in the drawings for showing elements that are the same or functionally similar to each other. In the specification, up and down correspond to an upper direction and a lower direction, respectively, in a gravity direction. A contact corresponds to a touch and a contact of members directly or via other members.

### First Embodiment

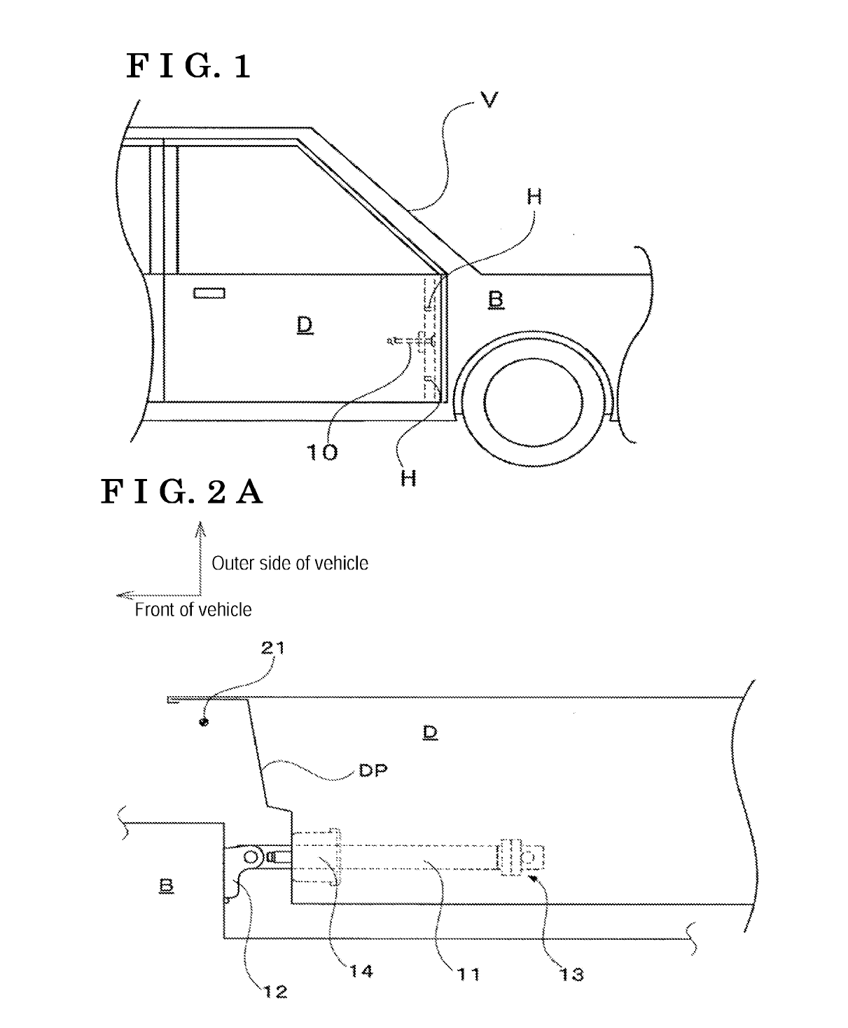

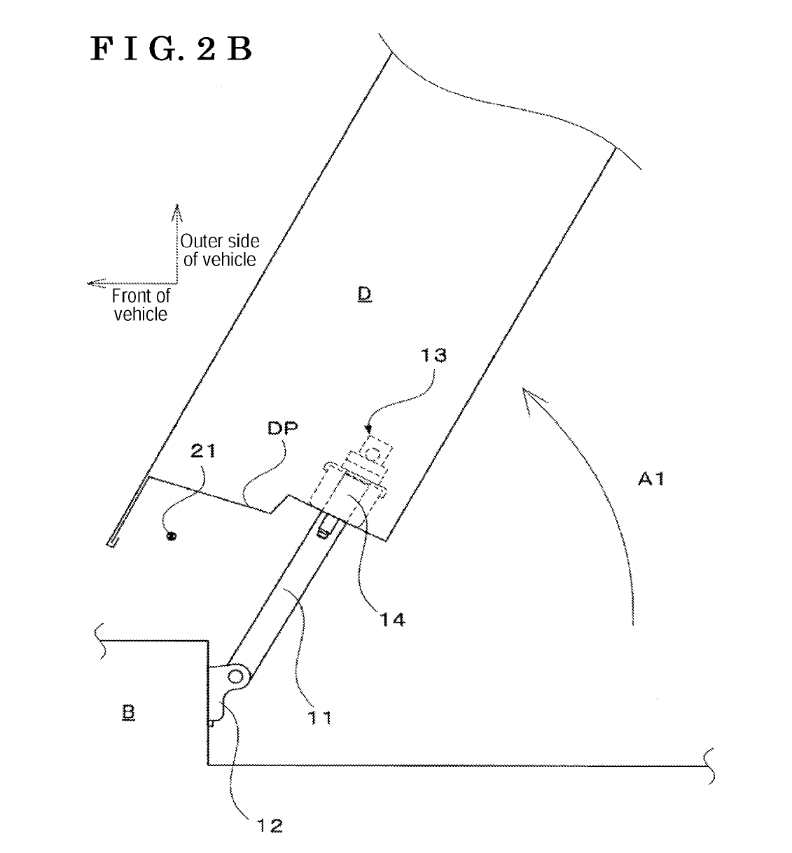

A door checking mechanism 10 will be explained with reference to FIGS. 1 through 2B. FIG. 1 is a view schematically illustrating a vehicle V being provided with a door D for the vehicle including a door checking mechanism 10. As FIG. 1 is referred, the door D for the vehicle is connected to a vehicle body B via a hinge H. The door checking mechanism 10 is provided within the door D of the vehicle at a position in the vicinity of a connection portion of the door D for the vehicle and the vehicle body B of the vehicle V. FIGS. 2A and 2B illustrate the movement of the door D and the door checking mechanism 10. The door D can rotate about a hinge shaft 21 shown in FIGS. 2A and 2B. The door checking mechanism 10 is provided within the door D for the vehicle and is supported at the vehicle body B via a bracket 12. The door checking mechanism 10 includes a check link 11, the bracket 12, a stopper portion 13, and a door check 14. The check link extends within the door D. The bracket 12 is supported at the vehicle body B. The stopper portion 13 is provided at an end portion of the check link 11 that is disposed within the door D. The door check 14 is connected to a door panel DP. The check link 11 is rotatably mounted on the vehicle body B at an end portion of the check link, the end portion where the stopper portion 13 is not provided via the bracket 12. The check link 11 passes through the door check 14 and extends within the door.

FIG. 2A illustrates the door D and the door checking mechanism 10 when the door D is in a fully-closed position. FIG. 2B illustrates the door D and the door checking mechanism 10 when the door D is in a fully-open position. In a case where a user opens the door D that is in the fully-closed position shown in FIG. 2A, the door D is open to an outer side of the vehicle along an arrow A1 in FIG. 2B. The check link 11 extending within the door D is pulled out of the door D in response to the movement of the door D. The stopper portion 13 prevents the check link 11 from being pulled out further by coming in contact with the door check 14. Because the check link 11 is prevented from being pulled out of the door D, the check link 11 prevents the door D from opening further. Thus, because the stopper portion 13 and the door check 14 of the door checking mechanism 10 come in contact with each other, the door D is restricted from opening.

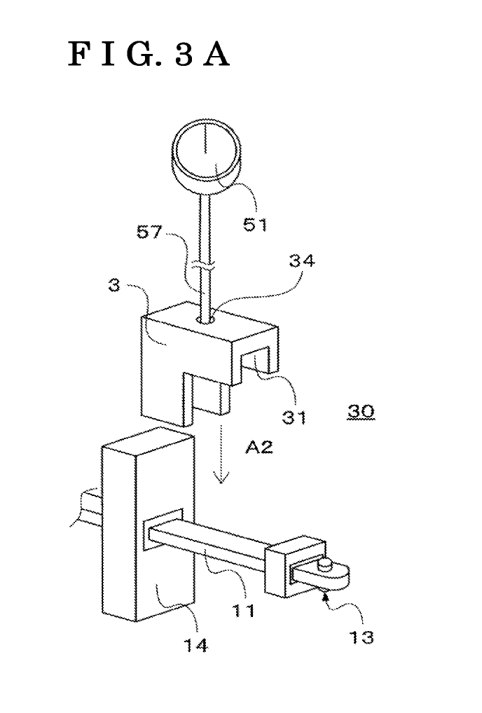

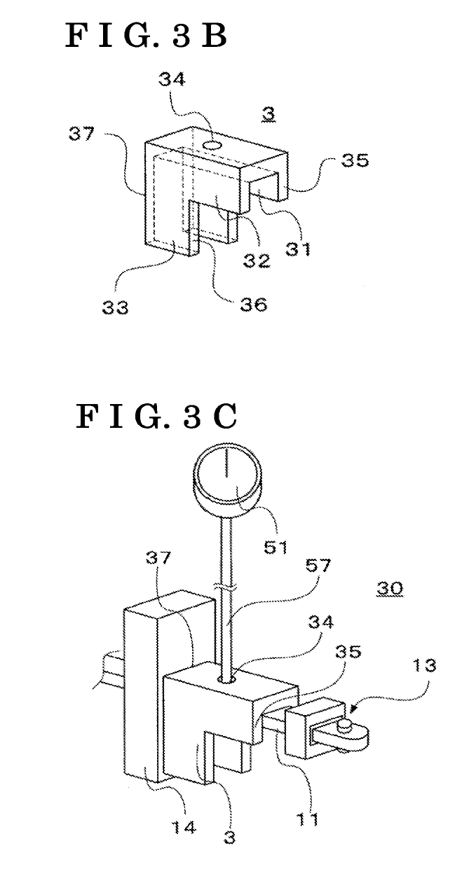

Next, a door checking mechanism 30 including an opening adjusting block 3 according to the first embodiment of the present invention will be explained with reference to FIGS. 3A through 6. FIG. 3A illustrates the door checking mechanism 30 including the opening adjusting block 3 according to the first embodiment. FIG. 3B illustrates the opening adjusting block 3 according to the first embodiment. FIG. 3C illustrates the opening adjusting block 3 after being disposed between the door check 14 and the stopper portion 13. The door D is not illustrated for simplifying the explanation in FIGS. 3A through 3C. According to the door checking mechanism 30 including the opening adjusting block 3 of the first embodiment, as shown in FIG. 3A, the opening adjusting block 3 is disposed above the check link 11. The opening adjusting block 3 is connected to a opening adjustment dial 51 via, for example, a cable 57, a wire, and a stick member and can move in the upper-lower directions by the operation of the opening adjustment dial 51. As shown in FIG. 3B, the opening adjusting block 3 includes a recess 31, a first leg portion 32, and a second leg portion 33. The recess 31 has the width that is greater than the width of the check link 11. The respective first and second leg portions 32, 33 extend from the recess 31 and are formed in a two-stage-step shape. The opening adjusting block 3 includes a hole portion 34 through which, for example, the cable 57, the wire and the stick member that are connected to the opening adjustment dial 51 for adjusting the position of the opening adjusting block 3 pass. In addition, the opening adjusting block 3 includes a first-side surface 35 (a second portion), a second-side surface 36 (a third portion) and a third-side surface 37 (a first portion). The first-side surface 35 is formed at the first leg portion 32. The second-side surface 36 is formed at the second leg portion 33. The third-side surface 37 faces the respective first and second-side surfaces 35, 36.

As shown in FIG. 3A, the opening adjusting block 3 is disposed above the check link 11 at a portion between the door check 14 and the stopper portion 13 in a case where the door D is set to be fully opened. Here, in a case where the opening adjustment dial 51 is operated to change the opening of the door D, the opening adjusting block 3 moves along an arrow A2, and as shown in FIG. 3C, the recess 31 is disposed on the check link 11 so as to contain the check link 11. As FIG. 3C is referred, the opening adjusting block 3 is disposed between the door check 14 and the stopper portion 13. When the door D is open at this state, the check link 11 is pulled out of the door D, and the stopper portion 13 comes in contact with the first-side surface 35. Accordingly, the door check 14 comes in contact with the third-side surface 37 and the opening adjusting block 3 is sandwiched between the stopper portion 13 and the door check 14. Thus, the opening adjusting block 3 is restricted from moving to a first end portion that is mounted on the vehicle body B by coming in contact with the door check 14 at the third-side surface 37. Furthermore, the opening adjusting block 3 restricts the check link 11 from moving to the first end portion of the check link 11 by coming in contact with the stopper portion 13 at the first-side surface 35. Thus, the opening adjusting block 3 can prevent the check link 11 from being pulled out of the door D by being sandwiched between the stopper portion 13 and the door check 14 and can prevent the door D from opening further. That is, the opening adjusting block 3 can restrict the opening movement of the door D by being disposed between the stopper portion 13 and the door check 14, and can restrict the opening of the door D. The opening of the door D corresponds to a moving distance of the check link 11 to the outer side of the door. Thus, the opening of the door D is restricted in accordance with the moving distance of the check link 11, the moving distance that is restricted by the opening adjusting block 3, that is, in accordance with a length of the opening adjusting block 3 that is sandwiched between the stopper portion 13 and the door check 14. Thus, the restricted opening of the door D corresponds to the length (the distance) of the opening adjusting block 3 that is sandwiched between the stopper portion 13 and the door check 14.

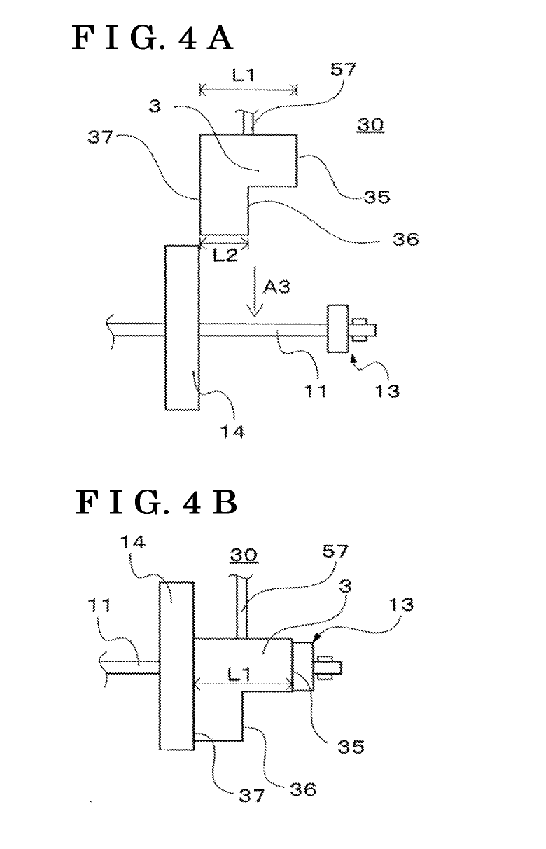

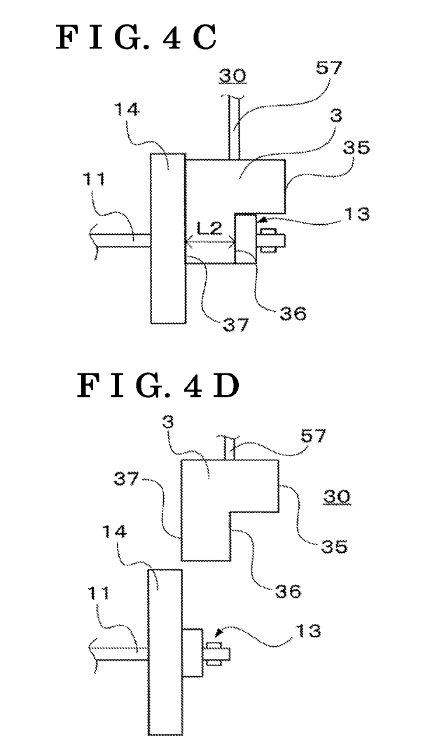

A method of opening adjustment of the door D using the opening adjusting block 3 will be explained with reference to FIGS. 4A through 4D. Each of FIGS. 4A through 4D shows a side view illustrating the check mechanism 30. FIG. 4A illustrates the check mechanism 30 before performing the opening adjustment of the door D. FIG. 4B illustrates the check mechanism 30 in a case where the opening of the door D corresponds to a first opening. FIG. 4C illustrates the check mechanism 30 in a case where the opening of the door D corresponds to a second opening that is greater than the first opening. FIG. 4D illustrates the check mechanism 30 in a case where the door D is fully open. The door D and the opening adjustment dial 51 are not illustrated for simplifying the explanation in FIGS. 4A through 4D. In the drawings, L1 shows the length from the first-side surface 35 to the third-side surface 37 of the opening adjusting block 3, and L2 shows the length from the second-side surface 36 to the third-side surface 37.

FIG. 4A shows the opening adjusting block 3 before performing the opening adjustment of the door D and corresponds to a case where the opening adjusting block 3 in FIG. 3A is viewed from a lateral position. In this state, in a case where the opening of the door D is set by the operation of the opening adjustment dial 51, the opening adjusting block 3 moves along an arrow A3 in response to the movement of the cable 57, and is disposed between the door check 14 and the stopper portion 13.

As shown in FIG. 4B, in a case where the opening of the door D is set at the first opening, the opening adjusting block 3 comes in contact with the stopper portion 13 at the first-side surface 35 when the opening operation of the door is performed. The opening adjusting block 3 is disposed at a position where the third-side surface 37 comes in contact with the door check 14. In this case, the opening adjusting block 3 can prevent the check link 11 from being pulled out of the door D by the length L1 and can restrict the opening of the door D at the first opening. That is, in this case, the opening adjusting block 3 can restrict the opening of the door D at the first opening that corresponds to the length L1.

As shown in FIG. 4C, in a case where the opening of the door D is set at the second opening that is greater than the first opening, the opening adjusting block 3 comes in contact with the stopper portion 13 at the second-side surface 36 when the opening operation of the door D is performed. The third-side surface 37 is disposed at a position where the third-side surface 37 comes in contact with the door check 14. In this case, the opening adjusting block 3 can prevent the check link 11 from being pulled out of the door D by the length L2. The opening of the door D is restricted at the second opening. That is, in this case, the opening adjusting block 3 can restrict the opening of the door D at the second opening that corresponds to the length L2.

In a case where the opening of the door D is set at a fully opening, the opening adjusting block 3 does not move from a position shown in FIG. 4A. Thus, as shown in FIG. 4C, the check link 11 can be pulled until the stopper portion 13 and the door check 14 come in contact with each other as conventional. The door D can be open to the fully-open position.

As such, the opening adjusting block 3 according to the first embodiment includes the recess 31 containing the check link 11, and is disposed between the door check 14 (a movement restriction portion) and the stopper portion 13 of the check link 11 so as to contain the check link 11 at the recess 31. In this case, in a case where the opening operation of the door D is performed, the opening adjusting block 3 can restrict the movement of the check link 11 to the opening direction of the door D for the vehicle, and can restrict the opening movement of the door D for the vehicle by coming in contact with the door check 14 and the stopper portion 13. That is, the opening of the door D for the vehicle can be restricted at an opening corresponding to a length where the opening adjusting block 3 is sandwiched between the door check 14 and the stopper portion 13. Furthermore, because the opening adjusting block 3 is simply constructed, the cost for door opening adjustment feature can be reduced. In addition, the opening adjusting block 3 further includes the first leg portion 32 and the second leg portion 33 extending from the recess 3. In this case, because one of the first leg portion 32 and the second leg portion 33 comes in contact with the door check 14 and the stopper portion 13, the movement of the check link 11 to the opening direction of the door D for the vehicle can be gradually restricted. That is, the opening of the door D for the vehicle can be gradually restricted. According to the first embodiment, the first and second leg portions are formed in the two-stage-step shape. Alternatively, stages can be desirably set. For example, a leg portion including a three-stage step, a four-stage step, or more than the four-stage step can be formed. The opening adjusting block 3 is connected to the opening adjustment dial 51 and can be disposed between the door check 14 and the stopper portion 13 in response to the operation of the opening adjustment dial 51. Accordingly, the door check 14 restricts the opening adjusting block 3 from moving to the first end portion of the check link 11, the first end portion mounted on the vehicle body B, and is disposed at a position where the opening adjusting block 3 comes in contact with the stopper portion 13. Thus, a user can adjust the opening of the door D for the vehicle by operating the opening adjustment dial 51.

In the first embodiment, the opening adjusting block 3 is disposed above the check link 11. A direction where the opening adjusting block 3 is disposed is not limited to this. That is, the opening adjusting block 3 has only to be disposed between the door check 14 and the stopper portion 13 so as to come in contact with and to be sandwiched between the door check 14 and the stopper portion 13. The opening adjusting block 3 can be disposed at any directions relative to the check link 11. For example, the opening adjusting block 3 may be disposed at a lateral position of the check link 11, or may be disposed at a lower position of the check link 11. Furthermore, the movement of the opening adjusting block 3 relative to the check link 11 is not limited to the sliding in the upper-lower direction. The opening adjusting block 3 may slide in any directions in accordance with the disposed position of the opening adjusting block 3, or may, for example, rotate to the check link 11 or rotate about an axis of the check link 11.

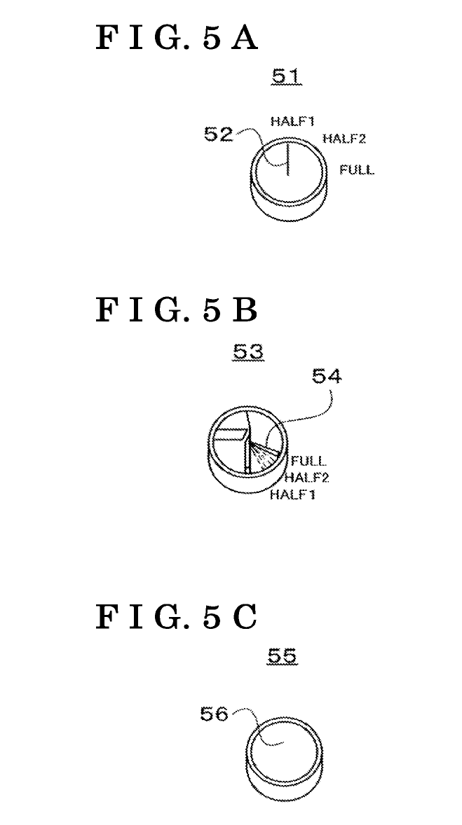

The opening adjustment of the door D for the vehicle can be performed manually by the operation of a user, or can be performed automatically by the detection of obstacles that are disposed at the lateral position of the vehicle. In a case where the opening adjustment of the door D for the vehicle is performed manually, an opening adjustment dial, a button, and a lever can be used, the opening adjustment dial, the button, and the lever that can perform the positioning of the opening adjusting block 3 via the cable 57 connected to the opening adjusting block 3. Here, each of FIGS. 5A through 5C illustrates an example of the opening adjustment dial. The opening adjustment dial 51 shown in FIG. 5A includes an index line 52. By matching the index line 52 to an indication showing a desired opening by rotating the opening adjustment dial 51, the opening of the door D for the vehicle may be adjusted. By using the opening adjustment dial 51, a user may visually see and perform the opening of the door D for the vehicle. An opening adjustment dial 53 shown in FIG. 5B shows another embodiment of the opening adjustment dial. According to the opening adjustment dial 53, an indicator 54 of the door D for the vehicle rotates in response to the rotation of the opening adjustment dial 53. By matching the indicator 54 of the door D for the vehicle to an indication showing a desired opening, the opening of the door D for the vehicle can be adjusted. Thus, a user can rotate the opening adjustment dial 53 and operate in connection with the indicator 54 of the door D for the vehicle and the actual opening of the door D. A user may operate the opening adjustment dial more intuitively. A display device 56 including a liquid crystal display or an organic electroluminescence display at a display portion of the opening adjustment dial can be used. That is, the opening adjustment dial can be provided with the display device 56 including the crystal liquid display or the organic electroluminescence display. FIG. 5C illustrates an opening adjustment dial 55 in this case. The opening adjustment dial 55 can display any image on the display device 56. Along with that, in a case where it is dark in the vehicle, the opening adjustment dial 55 can be easily operated by the light of the display device 56. In a case where a button is used instead of the opening adjustment dial, the button displayed at a touch panel display may be used other than a button such as a switch. The opening adjustment dial and the button, for example, can be provided at any positions of the door or of the vehicle, for example, at a door trim, at an armrest, and a dashboard that are not shown in the drawings.

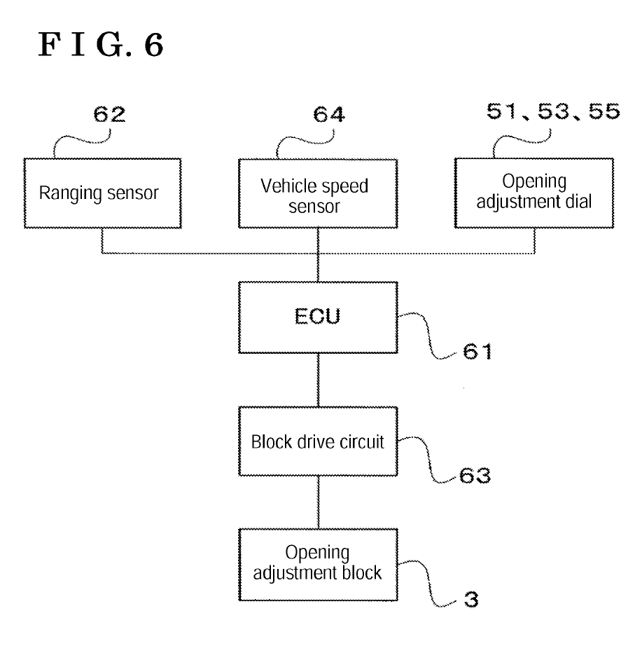

In a case where the opening adjustment of the door D for the vehicle is automatically performed, the opening adjustment can be performed based on the detection of the obstacles that are disposed at the lateral position of the vehicle. FIG. 6 illustrates a block diagram of, for example, a sensor and a control portion. An electric control unit 61, or an ECU 61 corresponds to a control portion including an ECU and a control processing unit, or a CPU. A ranging sensor 62 detects the obstacles disposed at the lateral position of the vehicle and measures a distance from the vehicle body B or the door D to the obstacles. A block drive circuit 63 includes an actuator for moving the opening adjusting block 3 and for positioning the opening adjusting block 3 between the door check 14 and the stopper portion 13. A vehicle speed sensor 64 corresponds to a sensor detecting a driving speed of the vehicle. Here, in a case where the ranging sensor 62 detects the obstacles disposed at the lateral position of the vehicle and measures the distance to the obstacles, the ranging sensor 62 transmits an obstacle detection signal including information relating to a measured distance to ECU 61. ECU 61 sets the opening of the door D, in response to the obstacle detection signal from the ranging sensor 62, in order for the door D not to come in contact with the obstacles when the door D opens. The setting of the opening can be performed by comparing, for example, the distance to the obstacles, the distance included in the obstacle detection signal, and the moving distance of the door D, the moving distance memorized in response to the opening. An appropriate opening among predetermined distances can be selected. For example, the opening can be set by selecting an opening that corresponds to the moving distance of the door D, the moving distance that is shorter than the distance to the obstacles, among the predetermined openings. In a case where the opening is set, ECU 61 transmits a block driving signal including information relating to the opening to the block drive circuit 63. The block drive circuit 63 drives the actuator in response to the block driving signal, moves the opening adjusting block 3, and restricts the opening of the door D for the vehicle. Accordingly, the opening adjusting block 3 is restricted from moving to the first end portion of the check link 11, the first end portion mounted on the vehicle body B by the door check 14, and is disposed at the position where the opening adjusting block 3 comes in contact with the stopper portion 13, in response to the obstacles disposed at the lateral position of the door D. That is, the opening adjusting block 3 can perform the opening adjustment of the door D for the vehicle automatically so as to be disposed between the door check 14 and the stopper 13 in response to the obstacles disposed at the lateral position of the door D. Only in a case where the vehicle speed sensor 64 detects that the vehicle is in a stopped state, unnecessary opening adjustment can be prevented from operating by performing the opening adjustment. For example, ECU 61 can prevent unnecessary opening adjustment by measuring the distance by the ranging sensor, or by sending the block drive signal only in a case where ECU 61 receives a vehicle stoppage signal showing the stoppage of the vehicle by the vehicle speed sensor 64.

In a case where the opening of the door D for the vehicle is adjusted manually, the actuator may move the opening adjusting block 3 without using the cable 57. For example, the door checking mechanism 30 can be configured such that ECU 61 drives the block drive circuit 63 and moves the opening adjusting block 3 in response to signals from the opening adjustment dial 51, 53, 55 to restrict the opening of the door D for the vehicle. In this case, the opening adjustment dial 51, 53, 55 transmits an opening adjustment signal to ECU 61 in response to the operation of a user. ECU 61 sets the opening of the door D for the vehicle on the base of the opening adjustment signal, and transmits the block driving signal to the block drive circuit 63. The block drive circuit 63 can restrict the opening of the door D for the vehicle by driving the actuator in response to the block driving signal and by moving the opening adjusting block 3.

According to the first embodiment, the opening adjusting block 3 is formed to include the recess 31, however, a shape of the opening adjusting block 3 is not limited to this. The opening adjusting block has only to restrict the opening movement of the door D and to restrict the opening of the door D by restricting the check link 11 from being pulled out, that is, by restricting the check link 11 from moving to the first end portion of the check link 11, the first end portion mounted on the vehicle body B. Thus, the opening adjusting block has only to include a first portion and a second portion. The first portion comes in contact with the door check 14. The second portion includes a predetermined distance in the moving direction of the check link 11 from the first portion. The opening adjusting block including this configuration can restrict the opening of the door D at the opening in accordance with the predetermined distance. In a case where the opening is set or restricted by the opening adjusting block, the door D is only restricted to be opened further than the opening. Thus, the door D can be desirably opened and closed within a range up to the opening that is restricted.

The opening adjusting block can include a third portion that includes a distance from the first portion, the distance shorter than the distance between the first portion and the second portion. In this case, the opening adjusting block can restrict the opening of the door D by restricting the check link 11 from moving to the first end portion of the check link 11, the first end portion mounted on the vehicle body B, in accordance with the distance between the first portion and the second portion, and the distance between the first portion and the third portion. That is, the opening adjusting block can gradually restrict the opening of the door D at an opening that is in accordance with the distance between the first portion and the second portion, or the distance between the first portion and the third portion. Portions for gradually restricting the opening of the door D are not limited to the second and third portions. A fourth portion including the distance from the first portion, the distance that is shorter than the aforementioned distance may be provided. Alternatively, any number of portions, the number that is greater than four, may be provided.

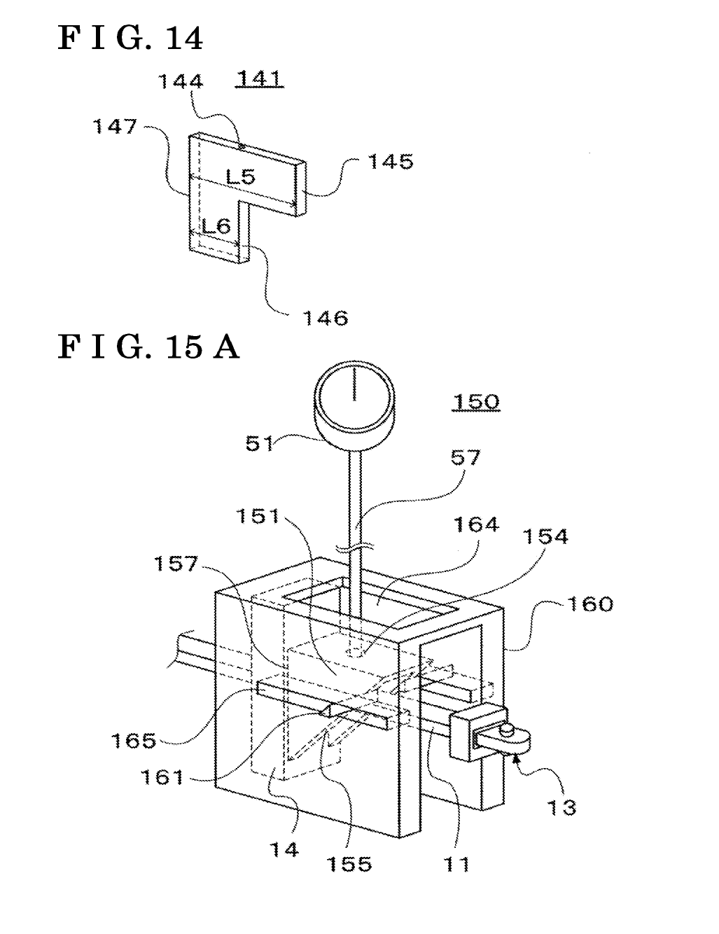

For example, the opening adjusting block can be formed with a single wall portion of the opening adjusting block 3 shown in FIG. 3B on the basis of the configuration. Such an opening adjusting block 141 is shown in FIG. 14. The opening adjusting block 141 is formed in a shape that corresponds to the wall portion of the opening adjusting block 3. The opening adjusting block 141 includes a first surface 145 (a second portion), a second surface 146 (a third portion), a third surface 147 (a first portion), and a hole portion 144 through which, for example, the cable 57 and the wire being connected to the opening adjustment dial 51 pass. Even in this case, the door check 14 (the movement restriction portion) comes in contact with the third surface 147 and restricts the opening adjusting block 141 from moving to the first end portion of the check link 11, the first end portion being mounted on the vehicle body B. Accordingly, in a case where the door check 14 restricts the opening adjusting block 141 from moving to the first end portion of the check link 11, the opening adjusting block 141 can restrict the check link 11 from moving to the first end portion of the check link 11 by coming in contact with the stopper portion 13 at the first surface 145 or at the second surface 146. Thus, the opening adjusting block 141 can restrict the door D from opening further than the predetermined opening, and can adjust the opening (the maximum opening) of the door D. The first surface 145 includes a predetermined distance (length) L5 from the third surface 147 in the moving direction of the check link 11. The second surface 146 includes a distance L6 from the third surface 147, the distance L6 that is shorter than the distance L5. Thus, the opening adjusting block 141 can gradually restrict the opening of the door D at an opening corresponding to the distance L5, or the distance L6. Because the configuration where the opening adjusting block 141 is disposed between the door check 14 and the stopper portion 13 is similar to the configuration where the opening adjusting block 3 is disposed, the explanation is not described. The first portion and the second portion are not limited to surfaces, and have only to be portions of the opening adjusting block that come in contact with the door check 14 and the stopper portion 13.

### Second Embodiment

Next, an opening adjusting block 7 according to a second embodiment of the present invention will be explained. Conventionally, regarding to a door for a vehicle, a door latch or a door lock restricts the door from opening in order to prevent the unintentional opening movement of the door while the vehicle is running. However, in a case where the door D is in a half-latched state where the door latch is fitted incompletely, or in a case where a user forgets to lock the door D, the door D may open unintentionally.

According to the second embodiment of the present invention, an opening adjusting block and a door checking mechanism including an opening adjustment feature will be provided, the opening adjusting block and the door checking mechanism restricting the check link from moving or transferring, for preventing the unintentional opening operation of a door.

That is, according to the second embodiment of the present invention, an opening adjusting block will be provided, the opening adjusting block including a recess contains the check link 11, the opening adjusting block having a length corresponding to a length between a door check and a stopper portion when the door is in the fully-closed state, the opening adjusting block being disposed between the door check and the stopper portion so as to contain the check link in the recess, the opening adjusting block restricts the movement of the check link in the opening direction of a door for a vehicle by coming in contact with the door check and the stopper portion.

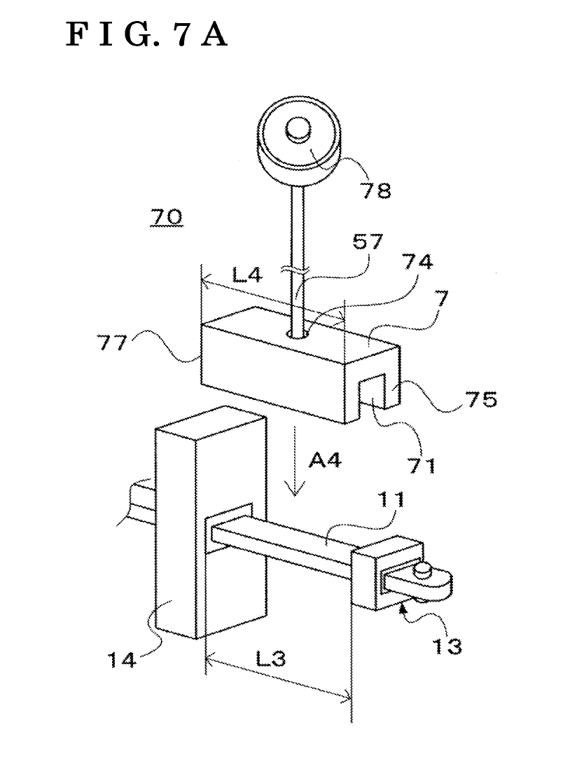

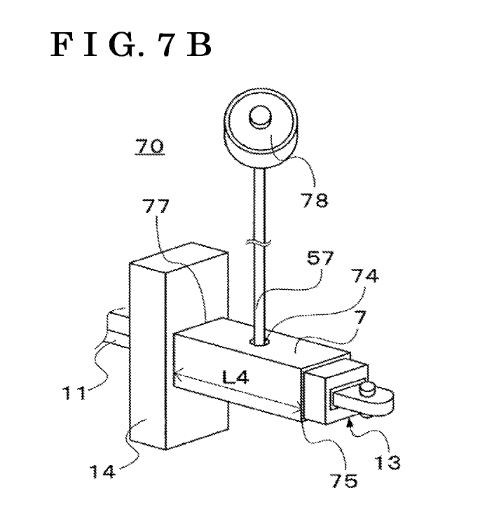

A door checking mechanism 70 including an opening adjusting block (an opening restriction block) 7 according to the second embodiment will be explained with reference to FIGS. 7A and 7B. FIG. 7A illustrates the opening adjusting block 7 and the door checking mechanism 70 of the second embodiment. FIG. 7B illustrates the door checking mechanism 70 in which the opening adjusting block 7 is disposed on the check link 11. The door checking mechanism 70 including the opening adjusting block 7 according to the second embodiment is provided with the opening adjusting block 7 above the check link 11 shown in FIG. 7A. The opening adjusting block 7 is connected to a button 78 via, for example, the cable 57, the wire, and the stick member and is able to move in the upper-lower directions by the operation of the button 78. As shown in FIG. 7A, the opening adjusting block 7 includes a recess 71 that contains the check link 11, a first-side surface 75 (a second portion), a second-side surface 77 (a first portion), and a hole portion 74 through which the cable 57 being connected to the button 78 passes. The opening adjusting block 7 is formed such that a length (a distance) from the first-side surface 75 to the second-side surface 77 corresponds to a length L4 that corresponds to a length L3 between the door check 14 and the stopper portion 13 when the door D is in the fully-closed state. Here, a length corresponding to the length L3 is a length that is equal to the length L3, or that is slightly shorter than the length L3. Because the length L4 is slightly shorter than the length L3, the opening adjusting block 7 can be easily disposed on the check link 11.

When the button 78 is operated, the opening adjusting block 7 moves along an arrow A4 in FIG. 7A, and is disposed between the door check 14 and the stopper portion 13 so as to contain the check link 11 in the recess 71. Here, because the opening adjusting block 7 has the length L4 that corresponds to the length L3 between the door check 14 and the stopper portion 13 when the door D is in the fully-closed state, the opening adjusting block 7 is disposed so as to come in contact with the door check 14 ad the stopper portion 13 when the door D is close to the fully-closed position shown in FIG. 7B. Thus, the opening adjusting block 7 restricts the check link 11 from being pulled out, that is, from moving to the first end portion of the check link 11, the first end portion mounted on the vehicle body B, and restricts the door D from opening. Accordingly, the opening adjusting block 7 according to the second embodiment can restrict the opening movement of the door D when the door D is close to the fully-closed position, and can prevent the door from opening unintentionally. The button 78 can be operated only when the door D is in the fully-closed state.

As such, the opening adjusting block 7 according to the second embodiment includes a recess 71 that contains the check link 11, and that has a length corresponding to a length between the door check 14 and the stopper portion 13 when the door is in the fully-closed state. That is, the distance between the second-side surface 77 and the first-side surface 75 of the adjustment block 7 corresponds to the distance between a portion of door check 14, the portion coming in contact with the second-side surface 77, and a portion of the stopper portion 13, the portion coming in contact with the first-side surface 75 when the door D is in the fully-closed state. The opening adjusting block 7 is disposed between the door check 14 and the stopper portion 13 of the check link 11 so as to contain the check link 11 in the recess 71. In this case, because the opening adjusting block 7 comes in contact with the door check 14 and the stopper portion 13 when the door D is close to the fully-closed portion, the opening adjusting block 7 can restrict the check link 11 from moving to the fully-opened direction of the door D for the vehicle, and can restrict the opening of the door D for the vehicle. Thus, the opening adjusting block 7 according to the second embodiment can restrict the door D from opening when the door D is close to the fully-closed position, and can prevent the unintentional opening operation of the door D.

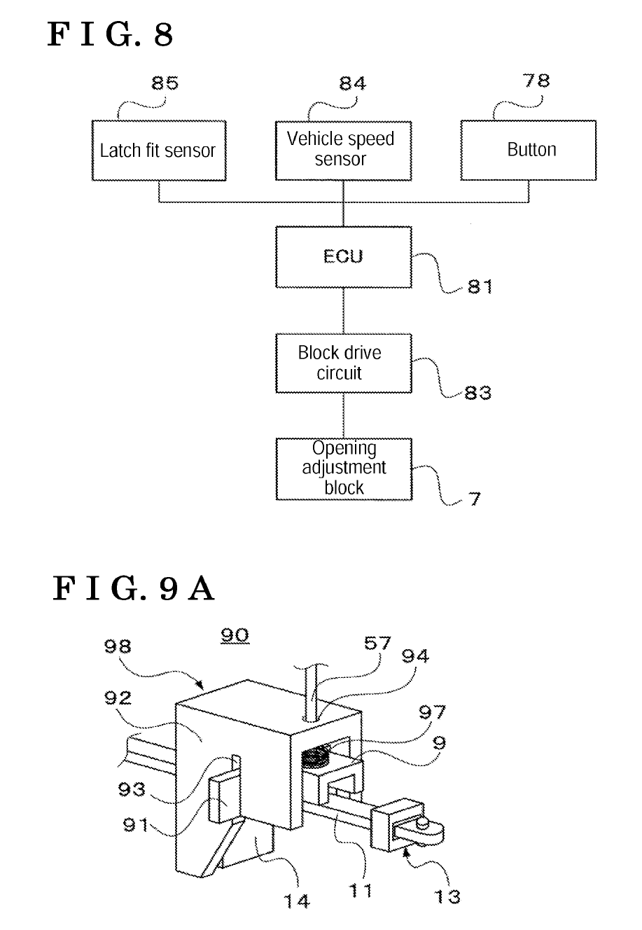

In a case where the vehicle sensor detects that the vehicle is running, the door checking mechanism 70 including the opening adjusting block 7 according to the second embodiment can be disposed automatically between the door check 14 and the stopper portion 13. FIG. 8 illustrates a block diagram of ECU and an actuator in this state. ECU 81 is a control portion including ECU and CPU being provided on the vehicle V. A vehicle speed sensor 84 is a sensor detecting the driving speed of the vehicle V. A block drive circuit 83 includes an actuator for moving and positioning the opening adjusting block 7 between the door check 14 and the stopper portion 13. In a case where the vehicle speed sensor 84 measures the vehicle speed and determines that the vehicle is running, the vehicle speed sensor 84 transmits a vehicle running signal to ECU 81. When receiving the vehicle running signal, ECU 81 transmits a block drive signal for moving the opening adjusting block 7 to the block drive circuit 83. The block drive circuit 83 drives based on the block drive signal, and disposes the opening adjusting block 7 between the door check 14 and the stopper portion 13. As such, because the door opening operation is restricted automatically in a case where the vehicle is running, the unintentional opening operation of the door D can be prevented while the vehicle is running. Accordingly, the opening adjusting block 7 is disposed between the door check 14 and the stopper portion 13 while the vehicle is running. That is, while the vehicle is running, the door check 14 restricts the opening adjusting block 7 from moving to the first end portion of the check link 11, the first end portion mounted on the vehicle body B, and the opening adjusting block 7 is disposed at a position where the opening adjusting block 7 comes in contact with the stopper portion 13. Because the door checking mechanism 70 is configured as mentioned above, failsafe can be achieved.

Furthermore, a latch fit sensor 85 detecting the latch that is released from being fitted, or the latch that in a half-latched state. In this case, in a case where ECU 81 receives a latch unfit signal showing that the latch is released or is half-latched from the latch fit sensor 85 while the vehicle speed sensor 84 detects that the vehicle is running, ECU 81 transmits the block drive signal to the block drive circuit 83. When receiving the block drive signal, the block drive circuit 83 disposes the opening adjusting block 7 between the door check 14 and the stopper portion 13. Accordingly, the opening operation of the door D can be restricted automatically by the detection in which the door may possibly open while the vehicle is running. Thus, the unintentional opening operation of the door D can be prevented while the vehicle is running. Thus, the door checking mechanism 70 including this configuration can achieve the failsafe of the door D for the vehicle.

In a case where the opening of the door D for the vehicle is adjusted manually, the actuator may move the opening adjusting block 7 without using the cable 57. For example, the door checking mechanism 70 can be configured such that ECU 81 controls the block drive circuit 83 to move the opening adjusting block 7, and restricts the opening of the door D for the vehicle on the basis of, a signal from the button 78. In this case, the button 78 transmits an opening control signal to ECU 81 in response to the user operation. ECU 81 transmits the block drive signal to the block drive circuit 83 on the basis of the opening control signal. The block drive circuit 83 drives the actuator and moves the opening adjusting block 7 on the basis of the block drive signal to restrict the opening of the door D for the vehicle.

### Third Embodiment

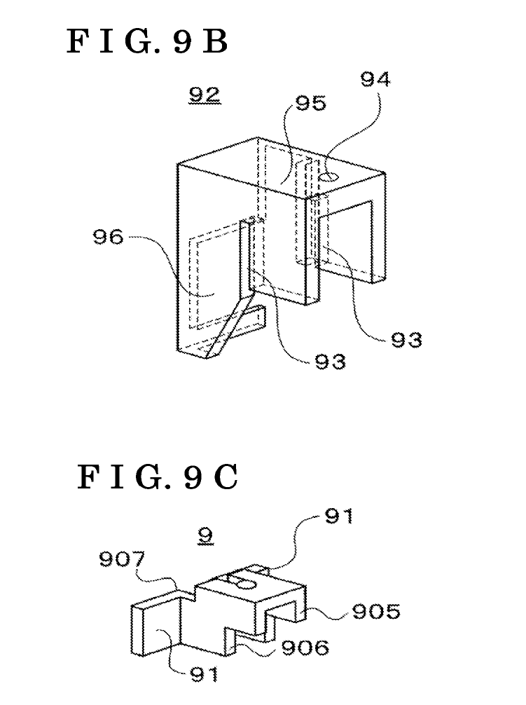

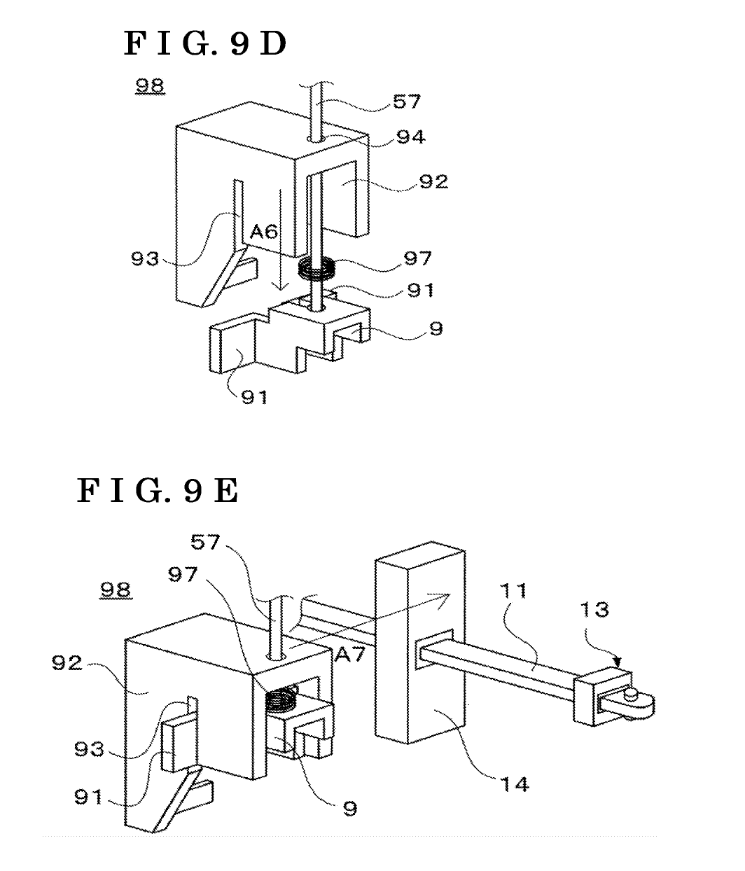

Next, an opening adjusting device 98 and a door checking mechanism 90 including an opening adjusting block 9 according to a third embodiment of the present invention will be explained with reference to FIGS. 9A through 9E. Here, because the movement of, for example, the opening adjusting block 9, is similar to the first embodiment, the difference will be mainly explained. FIG. 9A illustrates the door checking mechanism 90 including the opening adjusting block 9 according to the third embodiment. FIG. 9B illustrates a block case (a mount member) 92. FIG. 9C illustrates the opening adjusting block 9. FIG. 9D illustrates a view explaining the containment of the opening adjusting block 9 of the opening adjusting device 98 in the block case 92. FIG. 9E illustrates a view explaining the mounting of the opening adjusting device 98 to the door checking mechanism 90. The door D and the opening adjustment dial 51 are not illustrated in FIGS. 9A through 9E to simplify the explanation. The door checking mechanism 90 according to the third embodiment includes the opening adjusting block 9, the block case 92, and a spring 97 as shown in FIG. 9A. As shown in FIG. 9A, the block case 92 is formed so as to contain the opening adjusting block 9 and the door check 14. As shown in FIG. 9B, the block case 92 includes a pair of groove portions 93, a first opening 95, a second opening 96, and a hole portion 94. The pair of groove portions 93 is for engaging with the opening adjusting block 9. The first opening 95 is for containing the door check 14. The second opening 96 is for the check link 11 that passes therethrough. The hole portion 94 is for, for example, the cable 57 that passes therethrough. The pair of groove portions 93 is provided so as to extend in a direction substantially orthogonal to a moving direction of the check link 11 which passes through the block case 92. The opening adjusting block 9 is similar to the opening adjusting block 3 of the first embodiment, and includes a first surface 905, a second surface 906, and a third surface 907. As shown in FIG. 9C, the opening adjusting block 9 further includes a pair of protruding pieces 91 for slidably engaging with the pair of groove portions 93 when the opening adjusting block 9 is contained in the block case 92. The pair of protruding pieces 91 of the opening adjusting block 9 is integrally configured with the third surface 907 that faces the first surface 905 and the second surface 906 and that comes in contact with the door check 14. Alternatively, the third surface 907 can be provided separately from the pair of protruding pieces 91. That is, a pair of protruding pieces engaging with the pair of groove portions 93 between the third surface 907, and the first and second surfaces 905, 906 of the opening adjusting block 9 can be provided. Similarly to the opening adjusting block 3 of the first embodiment, the opening adjusting block 9 is connected to the opening adjustment dial 51 via, for example, the cable 57. Because the opening adjustment dial 51 is operated, the opening adjusting block 9 can move in the upper-lower directions. According to the third embodiment, an opening adjusting device 98 contains the opening adjusting block 9 in the block case 92. Because the block case 92 contains the door check 14, the opening adjusting device 98 can be provided with the door check 14.

As shown in FIG. 9D, the block case 92 contains the opening adjusting block 9 such that the pair of groove portions 93 engage with the pair of protruding pieces 91 of the opening adjusting block 9. Here, the spring 97 is provided between the block case 92 and the opening adjusting block 9, and the cable 57 connected to the opening adjusting block 9 passes through the hole portion 94 and the spring 97. Then, the block case 92 contains the opening adjusting block 9 by moving along an arrow A6. Accordingly, the opening adjusting device 98 including the opening adjusting block 9, the block case 92, and the spring 97 is configured. Next, the opening adjusting device 98 moves along an arrow A7 shown in FIG. 9E, and the door check 14 is inserted into the block case 92 through the first opening 95 while a side surface of the block case 92 is inhibited from coming in contact with the check link 11. After the door check 14 is inserted into the block case 92, the block case 92 is disposed so as to cover the door check 14. Along with that, the third surface 907 of the opening adjusting block 9 comes in contact with the door check 14 by the movement of the block case 92. As such, the door check 14 is contained in the block case 92, and the opening adjusting device 98 is mounted on the door D for the vehicle via the door checking mechanism 90. Here, the check link 11 extends outside of the door D through the second opening 96 of the block case 92, which are shown in FIG. 9A. FIG. 9A shows that the block case 92 contains the opening adjusting block 9 and the door check 14. Here, the opening adjusting block 9 is pressed against the check link 11 by the spring 97 and is disposed on the check link 11 so as to contain the check link 11 in the recess 71. Because the door check 14 and the opening adjusting block 9 are contained in the block case 92, the relative positions of the door check 14 and the opening adjusting block 9 are prevented from being disoriented. Thus, the opening adjusting block 9 can be disposed on the check link 11 more precisely. Thus, because the block case 92 is used, the opening adjusting block 9 may be disposed between the door check 14 and the stopper portion 13 more precisely.

As such, the opening adjusting device 98 of the third embodiment includes the block case 92 containing the door check 14 and the opening adjusting block 9. Because the block case 92 contains the door check 14, the opening adjusting device 98 is mounted on the door checking mechanism 90. By using the block case 92, the opening adjusting device 98 can dispose the opening adjusting block 9 between the door check 14 and the stopper portion 13 more precisely. According to the third embodiment, the block case 92 includes the pair of groove portions 93, and the opening adjusting block 9 includes the pair of protruding pieces 91 slidably engaging with the pair of groove portions 93. The opening adjusting block 9 is contained in the block case 92 such that the pair of protruding pieces 91 engages with the pair of groove portions 93. Accordingly, because the opening adjusting block 9 is restricted from moving within the block case 92, the relative positions of the door check 14 and the opening adjusting block 9 when the opening adjusting block 9 is disposed on the check link 11 are prevented from being disoriented. Thus, the opening adjusting block 9 can be disposed between the door check 14 and the stopper portion 13 more precisely. Furthermore, because the spring 97 is disposed between the opening adjusting block 9 and the block case 92, the opening adjusting block 9 can be disposed between the door check 14 and the stopper portion 13 on the basis of the biasing force of the spring 97. Thus, because the spring 97 is disposed between the opening adjusting block 9 and the block case 92, the opening adjusting block 9 can be easily disposed.

As mentioned above, the opening adjusting device 98 of the third embodiment is used at the door checking mechanism 90. The door checking mechanism 90 includes the door check 14 (movement restriction portion), the check link 11 and the stopper portion 13. The check link 11 includes the first end portion being rotatably mounted on the vehicle body B and extends within the door D for the vehicle. The stopper portion 13 is provided at a second end portion of the check link 11 extending within the door D for the vehicle. The door check 14 is fixed at the door D for the vehicle, and the check link 11 is movable in a longitudinal direction of the check link 11 relative to the door check 14 relatively. Here, the opening adjusting device 98 includes the opening adjusting block 9 and the block case 92. The opening adjusting block 9 is provided with the third surface 907 (the first portion) and the first surface 905 (the second portion). The first surface 905 has a predetermined distance from the third surface 907 in the moving direction of the check link 11. The block case 92 contains the opening adjusting block 9 and the door check 14 and is mounted on the door D. Because the block case 92 contains the door check 14, the opening adjusting device 98 includes the door check 14. The door check 14 comes in contact with the third surface 907 and restricts the opening adjusting block 9 from moving to the first end portion of the check link 11, the first end portion mounted on the vehicle body B. When the door check 14 restricts the opening adjusting block 9 from moving to the first end portion, the opening adjusting block 9 comes in contact with the stopper portion 13 at the first surface 905, and restricts the check link 11 from moving to the first end portion of the check link 11. Thus, the opening adjusting device 98 can set the opening of the door D and can prevent the door D from opening equal to or more than the preset opening. The block case 92 can inhibit the relative positions of the door check 14 and the opening adjusting block 9 from being disoriented, and can dispose the opening adjusting block 9 more precisely.

The opening adjusting block 9 of the door D includes the second surface (the third portion) 906 including a distance from the third surface 907, the distance that is shorter than a distance between the third surface 907 and the first surface 905. In this case, the opening of the door D may be restricted by restricting the check link 11 from moving to the first end portion of the check link 11, the first end portion mounted on the vehicle body B, in accordance with the distance between the third surface 907 and the first surface 905, or the distance between the third surface 907 and the second surface 906. That is, the opening adjusting block 9 can gradually restricts the opening of the door D in accordance with the distance between the third surface 907 and the first surface 905, or with the distance between the third surface 907 and the second surface 906. Portions for restricting the opening of the door D gradually are not limited to the first and second surfaces 905, 906. A fourth surface including a shorter distance from the third surface 907, or any number of surfaces (portions) more than four can be provided. The first portion and the second portion are not limited to surfaces, and have only to be portions of the opening adjusting block 9 that come in contact with the door check 14 and the stopper portion 13.

According to the third embodiment, the pair of groove portions 93 being disposed substantially orthogonal to the moving direction of the check link 11 is provided at the block case 92 and the pair of protruding pieces 91 slidably engaging with the pair of groove portions 93 is provided at the opening adjusting block 9. The configurations of groove portions and protruding pieces are not limited to this. For example, one groove portion can be provided at a block case and one protruding piece corresponding to the groove portion can be provided at an opening adjusting block. Similarly, more than three groove portions can be provided at the block case, and more than three protruding pieces corresponding to the groove portions can be provided at the opening adjusting block. Groove portions can be provided at the opening adjusting block, and the protruding pieces corresponding to the groove portions can be provided at the block case. A protruding piece does not have to be integrally formed with an opening adjusting block or a block case. For example, the protruding piece can be made from other member such as a stick member. That is, the protruding piece can be provided by the stick member that is mounted on the opening adjusting block or the block case. Respective groove portions can be provided at the opening adjusting block and at the block case, and the stick member is inserted into the groove portions to be connected, or engaged with the respective groove portions of the opening adjusting block and of the block case via the stick member.

According to the third embodiment, the door check 14 is contained in the block case 92 via the first opening 95 provided in a lateral direction. However, the configuration of the block case 92 is not limited to this. For example, the block case 92 can be configured such that the lower portion of the second opening 96 is removed and the second opening 96 corresponds to a recess without being provided with the first opening 95, and because the block case 92 covers the door check 14 from an upper portion, the block case 92 contains the door check 14. Furthermore, because the check link 11 passes through the second opening 96 without being provided with the first opening 95, the block case contains the door check 14 and is mounted on the door checking mechanism 90 and the door D. The block case 92 can be mounted on the door checking mechanism 90 and the door D from any directions, for example, from a lateral position, or from an upper portion, in accordance with the positioning direction of the opening adjusting block 9 relative to the check link 11.

In a case where the block case 92 is mounted on the door D for the vehicle, the block case 92 can be mounted on the door panel DP of the door D for the vehicle directly using any fixtures, for example, a bolt, or can be mounted on the door panel DP via the door check 14.

According to the opening adjusting device 98 of the third embodiment, the block case 92 contains the door check 14. Alternatively, a block case can be integrally formed with a door check.

According to the opening adjusting device 98 of the third embodiment, the door check 14 is used as a movement restriction portion restricting the opening adjusting block 9 from moving to the first end portion of the check link 11, the first end portion mounted on the vehicle body B. However, the movement restriction portion is not limited to the door check 14. Any member that has only to be able to restrict the opening adjusting block from moving to the first end portion by being fixed to the door D for the vehicle, and by coming in contact with any portion (a first portion) of an opening adjusting block can be applied. Thus, the movement restriction portion may be any member that is disposed between the door D for the vehicle or the door check 14 and the opening adjusting block, and that restricts the opening adjusting block from moving to the first end portion of the check link 11, the first end portion mounted on the vehicle. The movement restriction portion can be fixed at the door D for the vehicle directly, or can be fixed at the door D for the vehicle indirectly via other member.

Here, the movement restriction portion can be a retention member that is fixed at the door D for the vehicle and that restricts the opening adjusting block 9 from moving in the moving direction of the check link 11 by retaining the opening adjusting block 9. Such a retention member and a block case can be used. Hereinafter, an opening adjusting device of a modified example of the opening adjusting device 98 will be explained with reference to the opening adjusting device 98 shown in FIGS. 9A and 9E, the opening adjusting device using the block case as a retention member.

Here, the opening adjusting device 98 using the block case 92 as a retention member is similar to the opening adjusting device 98 using the door check 14 as a movement restriction portion according to the third embodiment, except for a point that the third surface 907 of the opening adjusting block 9 does not come in contact with the door check 14. As described above, the block case 92 is fixed at the door panel DP of the door D. Thus, the check link 11 can move in the longitudinal direction of the check link 11 relative to the block case 92 relatively. The block case 92 includes the pair of groove portions 93 being disposed substantially orthogonal to the moving direction of the check link 11. Thus, because the pair of protruding pieces 91 of the opening adjusting block 9 is slidably engaged with the pair of groove portions 93, the block case 92 can contain and retain the opening adjusting block 9 so as to restrict the opening adjusting block 9 from moving in the moving direction of the check link 11. Thus, the block case 92 comes in contact with the pair of protruding pieces 91 (the first portion) at the pair of groove portions 93 and can restrict the opening adjusting block 9 from moving to the first end portion of the check link 11, the first end portion being mounted on the vehicle body B. In this case, in a case where the block case 92 restricts the opening adjusting block 9 from moving to the first end portion of the check link 11, the first surface 905 (the second portion) comes in contact with the stopper portion 13 and the opening adjusting block 9 restricts the check link 11 from moving to the first end portion of the check link 11. Accordingly, the opening adjusting device 98 in which the block case 92 is used as the movement restriction portion can set the opening of the door D and can prevent the door D from opening equal to or more than the preset opening.

As mentioned above, according to the opening adjusting device 98 including the block case 92 as the movement restriction portion, because the block case 92 comes in contact with the pair of protruding pieces 91, the opening adjusting block 9 is restricted from moving to the first end portion of the check link 11, the check link 11 being mounted on the vehicle body B. Thus, the opening adjusting device 98 of this case does not have to include the door check 14.

According to the opening adjusting device 98 of this case, the opening adjusting block 9 is retained by the block case 92 so as not to move the opening adjusting block 9 to the first end portion of the check link 11, the first end portion mounted on the vehicle B, via the pair of protruding pieces 91 that comes in contact with the block case 92. Thus, the restricted opening of the door D is set in accordance with the length (the distance) from the portion (the pair of protruding pieces 91) of the opening adjusting block 9 that comes in contact with the block case 92 to the portion (the first surface 905) of the opening adjusting block 9 that comes in contact with the stopper portion 13. Here, the opening adjusting block 9 includes the portion (the second surface 906) for restricting the opening of the door gradually. Accordingly, the opening adjusting device 98 being provided with the block case 92 as the movement restriction portion can restrict the door check 11 from moving in accordance with the distance between the pair of protruding pieces 91 and the first surface 905, and the distance between the pair of protruding pieces 91 and the second surface 906, and can restrict the opening of the door gradually. Portions for gradually restricting the opening of the door are not limited to the first and second surfaces 905, 906. The fourth surface including a shorter distance from the pair of protruding pieces 91, or any number of surfaces (portions) more than four can be provided.

The pair of protruding pieces 91 being provided at the opening adjusting block 9 of the opening adjusting device 98 that includes the block case 92 as the movement restriction portion can be provided separately from the third surface 907 that faces the first surface 905 and the second surface 906. That is, a pair of protruding pieces that engages with the pair of groove portions 93 may be provided between the third surface 907 and the first and second surfaces 905, 906 of the opening adjusting block 9. Furthermore, the opening adjusting block 9 may be provided with a groove portion being disposed substantially orthogonal to the moving direction of the check link 11, and the block case 92 may be provided with a protruding piece that engages with the groove portion. The protruding piece does not have to be integrally formed with the opening adjusting block or the block case. For example, the protruding piece may be formed with other member such as a stick member. Moreover, the opening adjusting block and the block case may be provided with respective groove portions being disposed substantially orthogonal to the moving direction of the check link 11. The stick member may be inserted into the respective groove portions and the respective groove portions of the opening adjusting block and of the block case may be connected and engaged with each other via the stick member. The first portion and the second portion are not limited to surfaces, and may be a member of the opening adjusting block 9 that comes in contact with the block case 92 and the stopper portion 13.

According to the opening adjusting device, the opening adjusting block and the block case may be configured such that the block case restricts the opening adjusting block 9 from moving to the first end portion of the check link 11, the first end portion mounted on the vehicle body B, and that the opening adjusting block comes in contact with the stopper portion 13. Thus, the block case and the opening adjusting block may be disposed in any directions, for example, the lateral position or the lower position of the check link 11. The movement of the opening adjusting block 9 relative to the check link 11 is not limited to the sliding movement in the upper-lower directions. Alternatively, the sliding in any directions in accordance with the disposed position of the opening adjusting block 9 may be applied. Alternatively, for example, the rotation of the opening adjusting block 9 to the check link 11 or the rotation about the axis of the check link 11 may be applied. The groove portion can be configured in accordance with the movement of the opening adjusting block and in accordance with respective shapes of the opening adjusting block and of the protrusion. For example, the groove portion can be formed as a groove portion including any angles relative to the moving direction of the check link 11.

According to the opening adjusting device including the block case as the movement restriction portion, the block case does not have to contain the door check 14. The block case may be mounted on the door panel DP directly, or, via the door check 14. The block case can be integrally formed with the door check.

The configuration for restricting the opening adjusting block from moving to the first end portion of the check link 11, the first end portion mounted on the vehicle body B, by the contact of the block case and the opening adjusting block is not limited to a pair of the protruding pieces and a pair of the groove portions being mounted on the block case and the opening adjusting block. For example, because the block case comes in contact with the third surface 907 of the opening adjusting block 9, the opening adjusting device can restrict the movement of the opening adjusting block.

### Fourth Embodiment

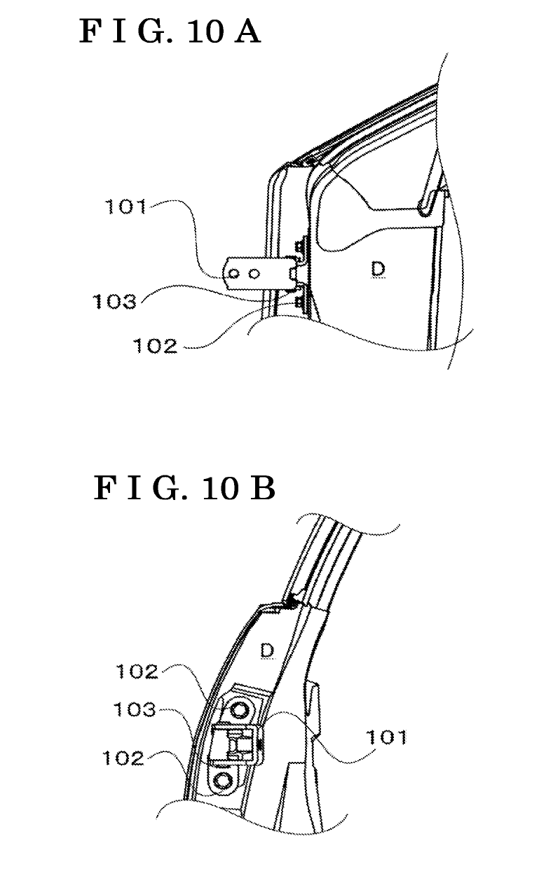

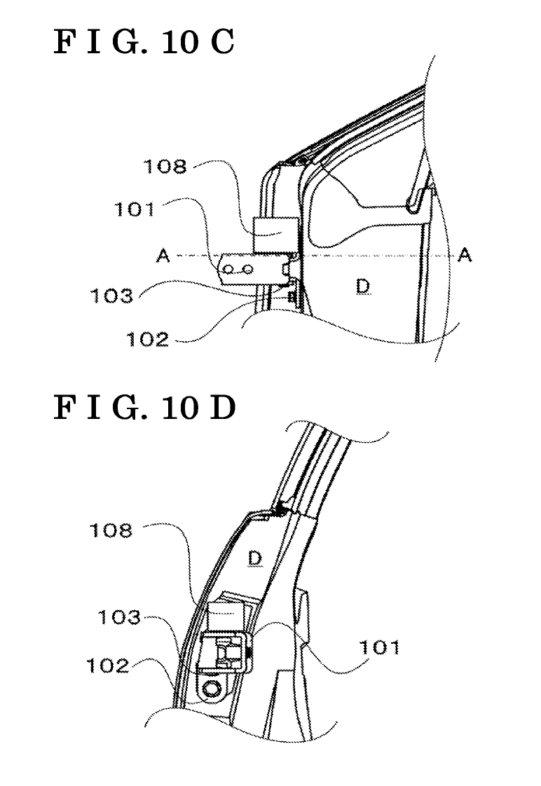

The mounting of an opening adjusting device 108 including an opening adjusting block 110 and a housing (a mount member) 104 of a fourth embodiment will be explained with reference to FIGS. 10A through 10D. Here, because the operation of the opening adjusting block 110 using the opening adjustment dial 51 is similar to the opening adjusting block in the first embodiment, the difference will be mainly explained. FIG. 10A illustrates a door hinge mechanism of a door for a vehicle. FIG. 10B illustrates a side view of the door hinge mechanism shown in FIG. 10A. The door D is connected to the vehicle body B via the door hinge mechanism and can rotate about a hinge shaft 103. The door hinge mechanism includes a body-side mounting piece 101 and a door-side mounting piece 102. The vehicle-side mounting piece 101 is mounted on the vehicle body B. The door-side mounting piece 102 is mounted on the door D. Here, FIGS. 10C and 10D illustrate the door D being provided with the opening adjusting device 108 that includes the opening adjusting block 110 and the housing 104. FIG. 10C corresponds to FIG. 10A, and FIG. 10D corresponds to FIG. 10B. As FIGS. 10C and 10D are referred, the opening adjusting device 108 is mounted on the door-side mounting piece 102 that is positioned at an upper portion of the door hinge mechanism, and the opening adjusting device 108 extends up to the upper portion of the vehicle-body-side mounting piece 101.

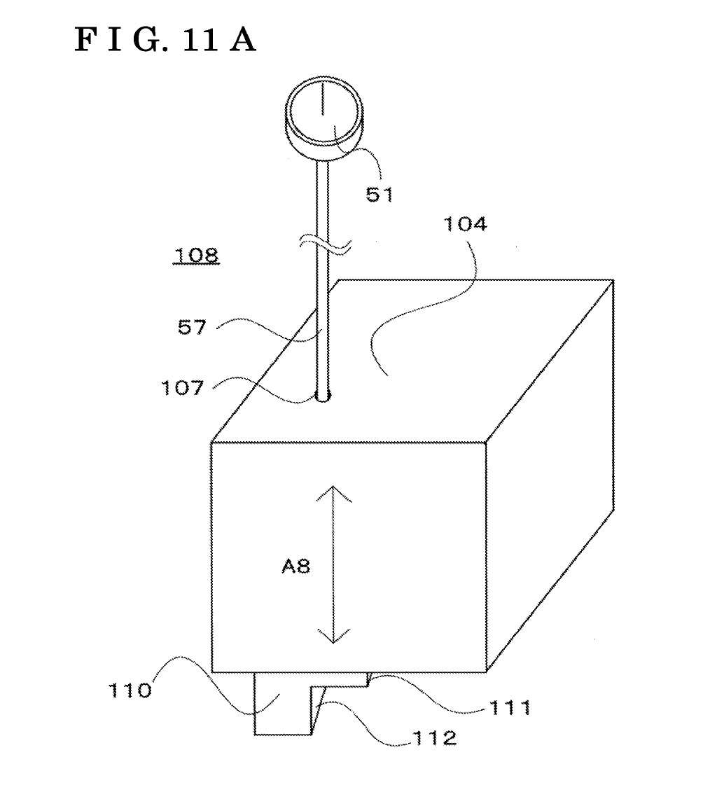

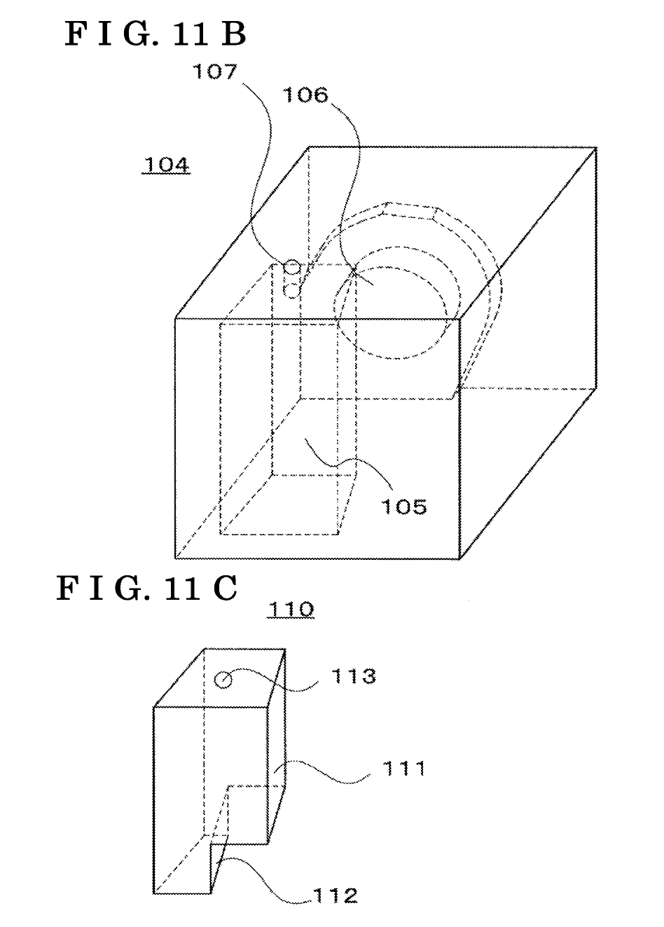

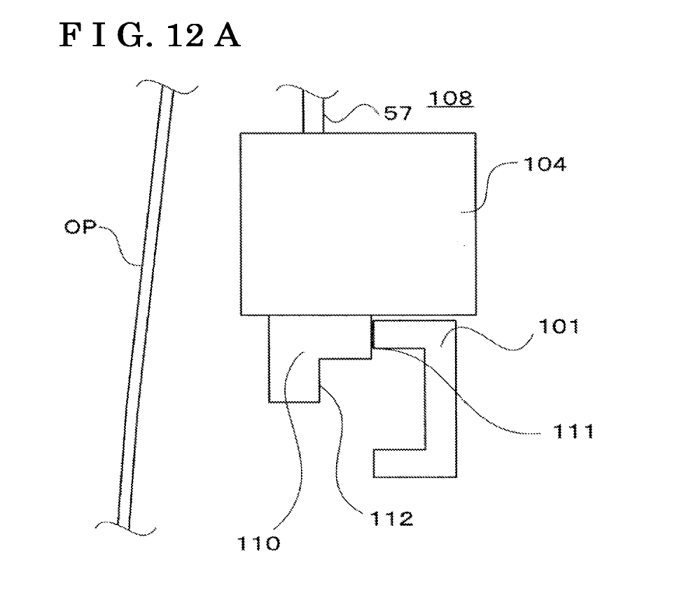

Next, the opening adjusting device 108 including the opening adjusting block 110 and the housing 104 of the fourth embodiment will be explained with reference to FIGS. 11 through 11C. FIG. 11A illustrates the opening adjusting device 108 that includes the opening adjusting block 110 and the housing 104 of the fourth embodiment. FIG. 11B illustrates the housing 104. FIG. 11C illustrates the opening adjusting block 110 that is contained in the housing 104. The opening adjusting device 108 is provided with the opening adjusting block 110 and the housing 104, and the housing 104 contains the opening adjusting block 110. As shown in FIG. 11B, the housing 104 includes a hollow portion 105, a fitting recess 106, and a hole portion 107. The hollow portion 105 is for containing the opening adjusting block 110. The fitting recess 106 engages with the door-side mounting piece 102 of the door hinge mechanism. The hole portion 107 is for, for example, the cable 57 that is connected to the opening adjusting block 110 and that passes therethrough. The opening adjusting block 110 has a step as shown in FIG. 11C and includes a first-step surface 111, a second-step surface 113, and a hole portion 113 through which, for example, the cable 57 being connected to the opening adjusting block 110 passes. The opening adjusting block 110 is connected to the opening adjustment dial 51 via, for example, the cable 57 passing through the hole portion 113, and is slidable in the upper-lower directions (a height direction) along an arrow A8 shown in FIG. 11A. The opening adjustment dial 51 includes the similar configuration as the opening adjustment dial described in the first embodiment.

The hollow portion 105 shown in FIG. 11B can contain the opening adjusting block 110. The opening adjusting block 110 moves downwardly in response to an operation of the opening adjustment dial 51 and can protrude from the housing 104. The state is shown in FIG. 11A. The fitting recess 106 of the housing 104 can be engaged with the door-side mounting piece 102 that is disposed at the upper portion of the door hinge mechanism shown in FIGS. 10A and 10B. Thus, the housing 104 can be mounted on the door D by the fitting recess 106 via the door-side mounting piece 102 that is disposed at the upper portion of the door hinge mechanism. The mounting of the housing 104 to the door D is not limited to this configuration. For example, a fixing member such as a bolt, or an adhesive agent may be used.

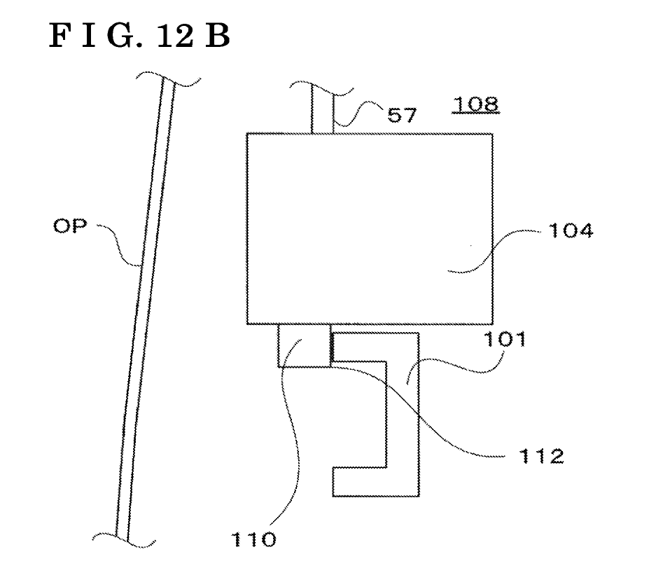

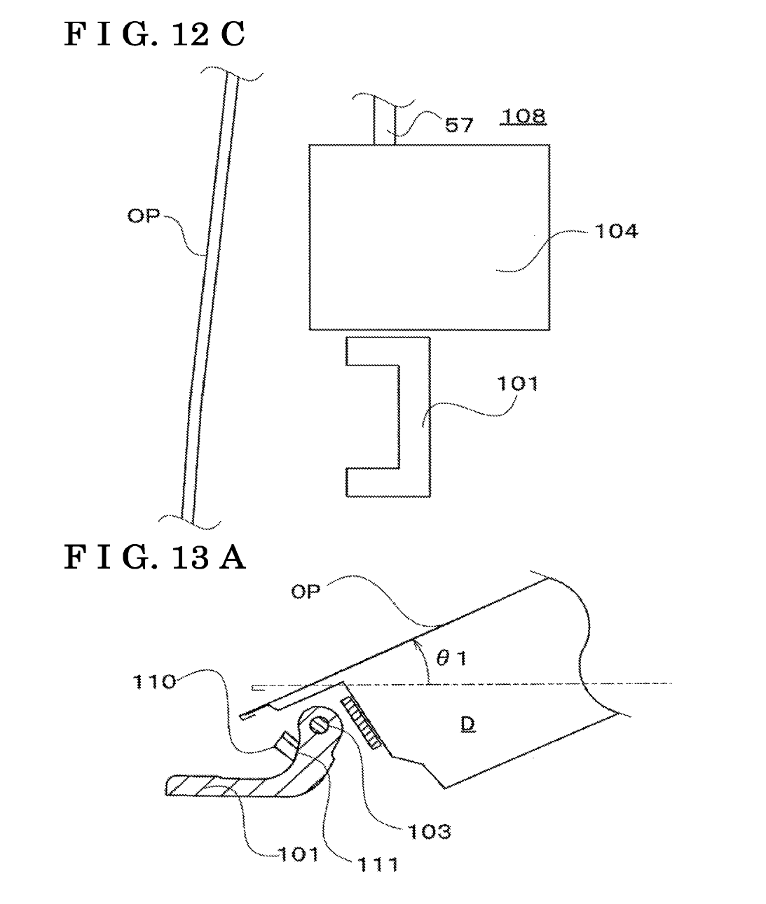

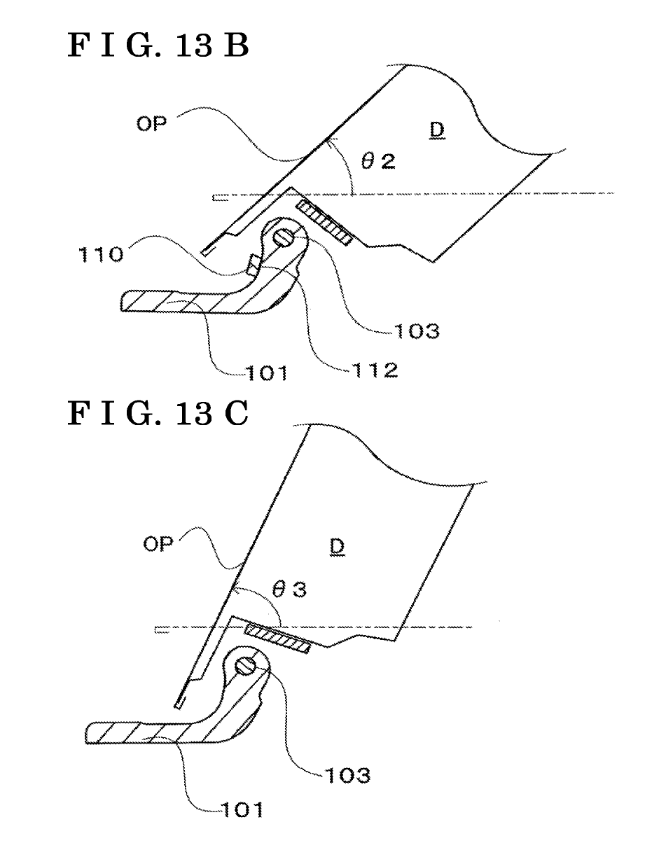

Next, the opening adjustment of the door D using the opening adjusting block 110 of the fourth embodiment will be explained with reference to FIG. 12A through FIG. 13C. FIG. 12A through FIG. 13C illustrate the movement of the door hinge mechanism including the opening adjusting device 108 and correspond to enlarged views of the vehicle-body-side mounting piece 101 of the hinge mechanism and the opening adjusting device 108 in FIG. 10D. FIG. 12A illustrates the door hinge mechanism in a case where the opening of the door D corresponds to a first opening. FIG. 12B illustrates the door hinge mechanism in a case where the opening of the door D corresponds to a second opening that is greater than the first opening. FIG. 12C illustrates the door hinge mechanism in a case where the opening of the door D corresponds to a full opening. Other components except for the vehicle-body-side mounting piece 101, the opening adjusting device 108 and the outer panel OP of the door D are not illustrated for simplifying the explanation. FIG. 13A through FIG. 13C are views explaining the restriction of the opening of the door D using the opening adjusting block 110 and are cross-sectional views of the door D taken along a line A-A shown in FIG. 10C. FIG. 13A through 13C are views illustrating the relationship between the opening adjusting block 110 and the vehicle-body-side mounting piece 101 of the door hinge.

FIG. 12A illustrates the opening adjusting device 108 and the vehicle-body-side mounting piece 101 of the door hinge in a case where the opening of the door D is set at the first opening. In FIG. 12A, because the opening of the door D is set at the first opening, the opening adjusting block 110 moves downwardly and protrudes from the housing 104. Accordingly, the first-step surface 111 of the opening adjusting block 110 protrudes from the housing 104. In a case where the door D opens, as shown in FIG. 12A, the first-step surface 111 of the opening adjusting block 110 comes in contact with the vehicle-body-side mounting piece 101 of the door hinge. Thus, as shown in FIG. 13A that corresponds to FIG. 12A, according to the opening adjusting block 110 being mounted on the door D via the housing 104, because the first-step surface 111 comes in contact with the vehicle-body-side mounting piece 101 of the door hinge, the door D is prevented from rotating equal to or more than an opening θ 1 and restricts the door D from opening.

FIG. 12B illustrates the opening adjusting device 108 and the vehicle-body-side mounting piece 101 of the door hinge in a case where the opening of the door D is set at the second opening. In FIG. 12B, because the opening of the door D is set at the second opening, the opening adjusting block 110 moves downwardly and protrudes from the housing 104. Accordingly, the second-step surface 112 of the opening adjusting block 110 protrudes from the housing 104. Here, when the door D opens, the second-step surface 112 of the opening adjusting block 110 comes in contact with the vehicle-body-side mounting piece 101 of the door hinge as shown in FIG. 12B. Accordingly, as shown in FIG. 13B that corresponds to FIG. 12B, because the second-step surface 112 comes in contact with the vehicle-body-side mounting piece 101 of the door hinge, the opening adjusting block 110 being mounted on the door D via the housing 104 prevents the door D from opening equal to or more than an opening θ 2, and restricts the rotation of the door D.

FIG. 12C illustrates the opening adjusting device 108 and the vehicle-body-side mounting piece 101 of the door hinge in a case where the opening of the door D is set at the full opening. In FIG. 12C, because the opening of the door D is set at the full opening, the opening adjusting block 110 does not move from the inside of the housing 104. Thus, the opening adjusting block 110 does not protrude from the housing 104. As shown in FIG. 13C that corresponds to FIG. 12C, when the door D opens, the vehicle-body-side mounting piece 101 of the door hinge does not come in contact with the opening adjusting block 110, and the door D can be rotated to a full opening θ 3.

As such, the opening adjusting block 110 of the fourth embodiment corresponds to an opening adjusting block that is mounted on the door D for the vehicle so as to be slidable in the height direction of the door D for the vehicle. When the door D for the vehicle rotates, the opening adjusting block 110 restricts the door D for the vehicle from rotating by coming in contact with the vehicle-body-side mounting piece 101 of the door hinge. Thus, the opening adjusting block 110 can restrict the opening of the door D for the vehicle. In a case where the opening is set or restricted by the opening adjusting block, the door D is only restricted from opening equal to or more than the predetermined opening. Thus, the door D can be desirably opened and closed within a range up to the opening that is restricted. Because the opening adjusting block 110 is simply configured, costs for opening adjustment feature can be reduced. The opening adjusting device 108 including the opening adjusting block 110 is provided with the housing 104 (the mount member) that contains the opening adjusting block 110, and that is mounted on the door D for the vehicle. The opening adjusting block 110 can be mounted on the door D for the vehicle via the housing 104. According to the opening adjusting device 108, the opening adjusting block 110 can be mounted on the door D for the vehicle more easily by the use of the housing 104. Thus, the opening of the door D for the vehicle may be restricted by using the door-side mounting piece 102 that is mounted on the door D for the vehicle and the door hinge mechanism that includes one of the opening adjusting block 110 and the opening adjusting device 108. The opening adjusting block 110 is formed to include a step, and includes the first-step surface 111 and the second-step surface 112. In this case, because the first-step surface 111 or the second-step surface 112 comes in contact with the vehicle-body-side mounting piece 101 of the door hinge, the rotation of the door D for the vehicle can be gradually restricted. According to the fourth embodiment, the opening adjusting block 110 is formed to include the two-stage step. Alternatively, a number of stage can be desirably provided, for example, three-stage step, four-stage step, or more than the four-stage step. The opening adjusting block 110 is connected to the opening adjustment dial 51 and is disposed at a position where the opening adjusting block 110 comes in contact with the vehicle-body-side mounting piece 101 of the door hinge. Accordingly, the opening of the door D for the vehicle can be adjusted by a user who operates the opening adjustment dial 51. An opening adjustment dial 55 that corresponds to the opening adjustment dial of another embodiment is provided with the display device 56 including the liquid crystal display or the organic electroluminescence display. In this case, desirable images can be shown on the display device 56. Moreover, in a case where it is dark inside the vehicle, the opening adjustment dial 55 can be easily operated by a light of the display device 56. Similarly to the first embodiment, the opening adjustment dial 53 shown in FIG. 5B can be used as an opening adjustment dial.

According to the fourth embodiment, the opening adjusting device 108 is disposed at the upper portion of the door hinge mechanism, however, a direction where the opening adjusting device 108 is disposed is not limited to this. That is, the opening adjusting block 110 has only to come in contact with the vehicle-body-side mounting piece 101 of the door hinge in response to the rotation of the door D. For example, the opening adjusting device 108 can be disposed at a lower portion relative to the door hinge mechanism. According to the fourth embodiment, the housing 104 is formed in a substantially rectangular shape. The form of the housing 104 is not limited to this, and may be, for example, a polyhedron shape, or an ellipsoid shape. The movement of the opening adjusting block 110 is not limited to the sliding in the upper-lower directions, and has only to correspond to the movement relative to the vehicle-body-side mounting piece 101 of the door hinge. For example, sliding and rotation in any directions towards a vehicle-side mounting piece may be applied.

According to the fourth embodiment, the opening adjusting block 110 is mounted on the door D via the housing 104, however the configuration in which the opening adjusting block 110 is mounted on the door D is not limited to this. For example, a groove extending in the upper-lower directions (the height directions) is provided at an inner panel of the door D, and the opening adjusting block is provided with a protrusion engaging with the groove. Accordingly, the opening adjusting block can be directly mounted on the door D so as to be slidable in the upper-lower directions (the height direction).

The opening adjusting block 110 of the fourth embodiment, similarly to the opening adjusting block 3 of the first embodiment, the opening can be adjusted automatically by using an actuator. In a case where the opening is adjusted manually, the opening adjusting block can be moved by using the actuator.

### Fifth Embodiment

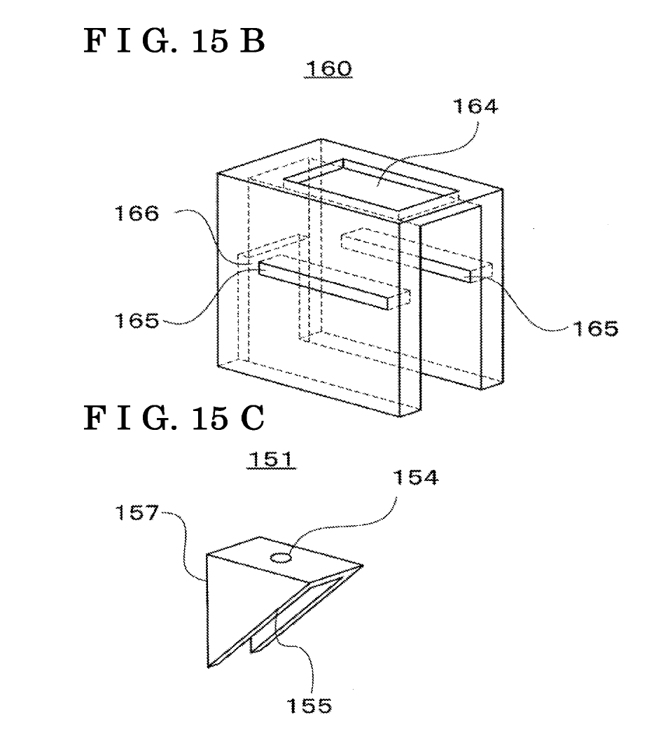

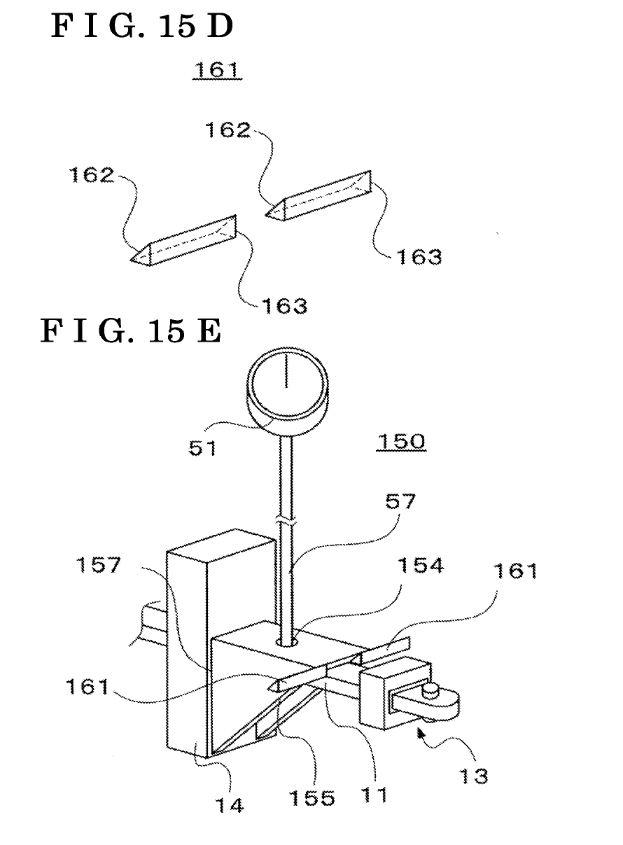

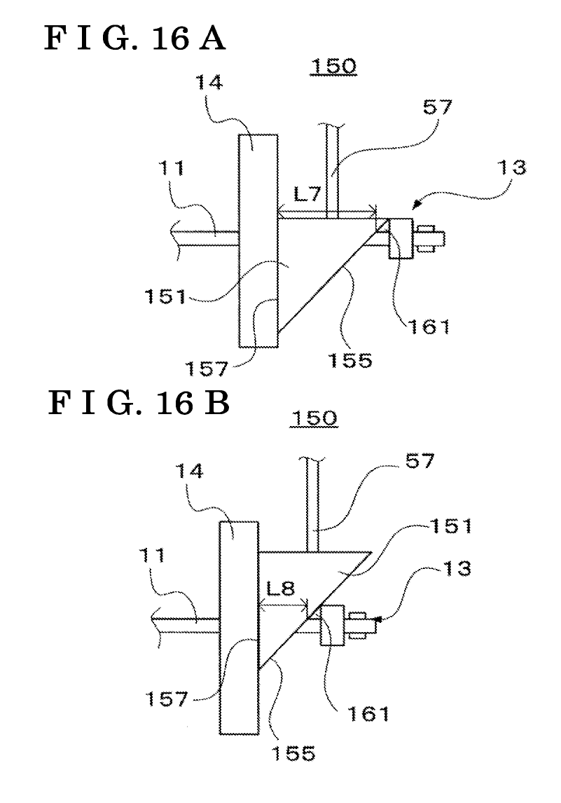

According to the first embodiment, the opening adjusting block that includes the recess and the two-stage step is shown. Alternatively, the opening adjusting block can be formed so as to have a shape that can adjust or restrict the opening of the door D for the vehicle in a stepless manner, that is, at desirable openings. For example, as shown in FIG. 15C, the opening adjusting block can set and restricts the opening of the door D for the vehicle in the stepless manner by being formed in a wedge shape. Hereinafter, a door checking mechanism 150 of a fifth embodiment will be explained with reference to FIG. 15A through FIG. 16B. Here, the operation of the opening adjustment dial 51 is similar to the operation of the opening adjustment dial 51 of the first embodiment, the difference will be mainly explained. FIG. 15A illustrates the door checking mechanism 150 including a wedge-shaped opening adjusting block 151 and a housing 160. FIG. 15B illustrates the housing 160. FIG. 15C illustrates the wedge-shaped opening adjusting block 151. FIG. 15D illustrates a positional restriction member 161. FIG. 15E illustrates the door checking mechanism 150 that is shown without the housing 160 for explanation. The door D is not illustrated in FIGS. 15A and 15E for simplifying the explanation.

As shown in FIG. 15A, the door checking mechanism 150 is provided with the door check 14, the check link 11, the stopper portion 13, the opening adjusting block 151, the housing 160, and the positional restriction member 161. The housing 160 contains the opening adjusting block 151, the positional restriction member 161 and the door check 14, and is mounted on the door D for the vehicle via the door checking mechanism 150. As shown in FIG. 15B, the housing 160 includes an opening 164 through which the opening adjusting block 151 passes, an opening (a guide portion) 165 through which the positional restriction member 161 passes, and an opening 166 through which the check link 11 passes. As shown in FIG. 15C, the opening adjusting block 151 is provided with a first surface 155 being tilted by a predetermined angle relative to the stopper portion 13, a second surface 157 that faces the first surface 155, and a hole portion 154 through which, for example, the cable 57 and the wire being connected to the opening adjustment dial 51 pass. The opening adjusting block 151 is contained in the housing 160 via the opening 164. As shown in FIG. 15D, the positional restriction member 161 includes a surface 162 coming in contact with the first surface 155, and a surface 163 coming in contact with the stopper portion 13. The positional restriction member 161 is contained within the housing via the opening 165, and is supported by the opening 165. Here, the opening 165 is formed along the moving direction of the check link 11, and the positional restriction member 161 can slide in the moving direction of the check link 11 along the shape of the opening 165. The positional restriction member 161 is biased by a biasing member, for example, a spring which is not shown in the drawings, in a direction to the door check 14. By coming in contact with the opening adjusting block 151, the positional restriction member 161 biases the opening adjusting block 151 in the direction towards the door check 14.

The opening adjusting block 151 can move in the upper-lower directions by the operation of the opening adjustment dial 51 being connected to the opening adjusting block 151 via the cable 57. Accordingly, similarly to the opening adjusting block 3 of the first embodiment, the opening adjusting block 151 can be disposed between the door check 14 and the stopper portion 13 in accordance with the operation of the opening adjustment dial 51. FIG. 15E illustrates an inside of the housing 160 at this point. As shown in FIG. 15E, because the first surface 155 of the opening adjusting block 151 comes in contact with the surface 162 of the positional restriction member 161 and is biased in the direction to the door check 14, the second surface 157 comes in contact with the door check 14 to inhibit the opening adjusting block 151 from being disoriented based on the movement in the upper-lower directions. Thus, the opening adjusting block 151 can be disposed more precisely between the door check 14 and the stopper portion 13. Because the second surface 157 comes in contact with the door check 14, the door check 14 restricts the opening adjusting block 151 from moving to the first end portion of the check link 11, the first end portion mounted on the vehicle body B. In a case where the door D is opened after the opening adjusting block 151 is disposed, the surface 163 of the positional restriction member 161 comes in contact with the stopper portion 13. Accordingly, the opening adjusting block 151 restricts the check link 11 from moving to the first end portion of the check link 11, the first portion mounted on the vehicle body B. Thus, the opening adjusting block 151 is sandwiched between the door check 14 and the stopper portion 13 via the positional restriction member 161 and restricts the opening (the maximum opening) of the door D by restricting the check link 11 from moving to the outside of the door. As shown in FIGS. 15D and 15E, the surface 162 of the positional restriction member 161 is formed as an inclination surface along the first surface 155. Thus, the opening adjusting block 151 comes in contact with the positional restriction member 161 at a wider area, and as a result, the opening adjusting block 151 comes in contact with the stopper portion 13 at the wider area via the positional restriction member 161. Thus, the opening adjusting block 151 can be inhibited from being disoriented or moving due to an impact of the contact of the opening adjusting block 151 with the stopper portion 13.

FIG. 16 is a side view for explaining an opening adjustment method of the door D by using the door checking mechanism 150 that is provided with the wedge-shaped opening adjusting block 151. FIG. 16A illustrates the door check 150 in a case where the opening operation of the door D corresponds to the first opening that is restricted the most within an adjustable range. FIG. 16B illustrates the door checking mechanism 150 in a case where the opening of the door D corresponds to the second opening that corresponds to a middle opening within the adjustable range. Here, the adjustable range of the opening of the door D corresponds to the opening (the maximum opening) of the door D that can be adjusted and restricted by using the opening adjusting block 151. The door D, the opening adjustment dial 51, and the housing 160 are not illustrated for simplifying the explanation in FIGS. 16A and 16B.

The first surface 155 of the opening adjusting block 151 is formed as an inclination surface inclining by a predetermined angle relative to the stopper portion 13. Thus, the distance between the second surface 157 and the first surface 155 changes continuously along the inclination of the first surface 155. Thus, in a case where the opening adjusting block 151 is sandwiched between the door check 14 and the stopper portion 13, the opening adjusting block 151 can restrict the check link 11 from moving to the outside of the door only by a distance from the second surface 157, the distance that corresponds to the portion of the first surface 155 coming in contact with the stopper portion 13, via the positional restriction member 161. Thus, the opening adjusting block 151 can restrict the opening of the door D at an opening in response to the distance from the second surface 157.

FIGS. 16A and 16B illustrate the movement of the opening adjusting block 151 in a case where the opening of the door D is adjusted. In a case where a user operates the opening adjustment dial 51 to adjust the opening of the door D, similarly to the first embodiment, the opening adjusting block 151 moves in the upper-lower directions in accordance with the operation of the opening adjustment dial 51. First, a user operates the opening adjustment dial 52 to adjust the opening of the door D at the opening (a first opening) in which the opening operation of the door D is restricted the most. In a case where the opening of the door is adjusted at the first opening by the opening adjustment dial 51, the opening adjusting block 151 is disposed at a position where the stopper portion 13 comes in contact with a portion of the first surface 155, the portion extending to the stopper portion 13 at a maximum via the positional restriction member 161. Then, when the door D is opened and the opening adjusting block 151 is sandwiched between the door check 14 and the stopper portion 13, the stopper portion 13 comes in contact with the portion of the first surface 155, the portion including a longest distance L7 from the second surface 157, via the positional restriction member 161 as shown in FIG. 16A. Thus, the opening adjusting block 151 can restrict the opening of the door D at the first opening that corresponds to the distance L7, that is, at an opening where the opening operation of the door D is restricted the most within the adjustable range. According to the fifth embodiment, a longest distance from the second surface 157 to the first surface 155 at a position where the surface 162 of the positional restriction member 161 comes in fully contact with the opening adjusting block 151 corresponds to the distance L7.

Next, a user operates the opening adjustment dial 51 and adjusts the opening of the door D at a middle opening (a second opening) within the adjustable range. In this case, as shown in FIG. 16B, the opening adjusting block 151 is disposed at a position where the stopper portion 13 comes in contact with a middle portion of the first surface 155 via the positional restriction member 161. Then, in a case where the door D is opened, and in a case where the opening adjusting block 151 is sandwiched between the door check 14 and the stopper portion 13, the stopper portion 13 comes in contact with a portion of the first surface 155, the portion having a distance L8 that is substantially a half of the distance L7 from the second surface 157, via the positional restriction member 161. Thus, the opening adjusting block 151 can restrict the opening of the door D at the second opening that corresponds to the distance L8, that is, at the middle opening within the adjustable range.

As such, according to the door checking mechanism 150 using the wedge-shaped opening adjusting block 151 of the fifth embodiment, the distance between the first surface (the second portion) 155 and the second surface (the first portion) 157 is continuously changed along an inclination of the first surface 155 which corresponds to the inclination surface. Thus, because the opening adjusting block 151 is disposed at a desired position and adjusts the portion of the first surface 155 that comes in contact with the stopper portion 13, the opening of the door D can be adjusted to an angle that corresponds to the distance between the second surface 157 and the first surface 155. Thus, because the opening adjusting block 151 is used, the opening of the door D can be adjusted or restricted in the non-step manner within the adjustable range. Because the positional restriction member 161 that includes the surface 162 along the first surface 155 is used, the opening adjusting block 151 comes in contact with the stopper portion 13 at the wider area, and the opening adjusting block 151 can be prevented from being disoriented or moving due to an impact of the contact of the opening adjusting block 151 with the stopper portion 13. Furthermore, because the housing 160 is used, the opening adjusting block 151 can be disposed more precisely and the positional restriction member 161 can be slidably supported in the moving direction of the check link 11. The positional restriction member 161 can be biased in a direction to the outside of the door, that is, in a direction towards the first end portion of the check link 11, the first end portion mounted on the vehicle body B. Thus, because the opening adjusting block 151 that comes in contact with the positional restriction member 161 can be biased similarly to the positional restriction member 161, the opening adjusting block 151 can be disposed more precisely.

According to the fifth embodiment, the adjustable range can be set based on a longest distance between the second surface 157 and the first surface 155, based on a size of the positional restriction member 161, and based on respective inclination angles of the first surface 155 and of the surface 162 of the positional restriction member 161. For example, in a case where the longest distance between the second surface 157 and the first surface 155 corresponds to a length corresponding to the length of the door check 14 and the stopper portion 13 when the door D is fully closed, a minimum value of the adjustable range of the door D (the opening in which the opening operation of the door D is restricted the most) can be the opening of the door D when the door D is fully closed. By downsizing the positional restriction member 161, or by reducing the respective inclination angles of the first surface 155 and of the surface 162, the maximum value of the adjustable range of the door D (the opening in which the opening operation of the door D is restricted the least) can be increased, that is, the maximum value can be close to the opening of the door D when the door D is fully opened.

According to the fifth embodiment, the door checking mechanism 150 is configured such that the opening adjusting block 151 comes in contact with the stopper portion 13 via the positional restriction member 161. Alternatively, the opening adjusting block 151 has only to restrict the check link 11 from moving to the outside of the vehicle by being sandwiched between the door check 14 and the stopper portion 13. Thus, the door checking mechanism 150 can be configured such that the opening adjusting block 151 directly comes in contact with the stopper portion 13 without the positional restriction member 161. In this case, the opening adjusting block 151 can be prevented from being disoriented or moving due to an impact of the contact of the opening adjusting block 151 with the stopper portion 13 by adjusting the inclination angle of the second surface, and by adjusting the weights and the materials of the opening adjusting block 151 and the stopper portions 13. In a case where the positional restriction member 161 is not used, because the stopper portion 13 is formed in a shape that is along the first surface 155, the opening adjusting block 151 can come in contact with the stopper portion 13 at the wider area. Thus, the opening adjusting block 151 can be prevented from being disoriented or moving due to an impact of the contact of the opening adjusting block 151 with the stopper portion 13. In a case where the positional restriction member 161 is not used, the door checking mechanism 150 can be configured as a door checking mechanism that is not provided with the housing 160 as, for example, in the first embodiment.

The shape of the opening adjusting block 151 of the fifth embodiment is not limited to a wedge shape. The shape of the opening adjusting block 151 has only to correspond to a shape including a second surface that is inclined by a predetermined angle relative to the stopper portion 13 so that the opening adjustment of the door D may be performed in the non-step manner within adjustable range. For example, a surface of a rectangular parallelepiped may be formed as a first surface that corresponds to an inclination surface. An opening adjusting block may be formed such that a portion of the first surface having the longest distance from stopper portion 13 includes the distance L8 from the opposing second surface. In this case, the opening adjusting block can perform the opening adjustment of the door D in the non-step manner within the adjustable range from the first opening corresponding to the distance L7 to the second opening corresponding to the distance L8.

The shape of the opening adjusting block 151 of the fifth embodiment is not limited to a shape including a recess, and may be, for example, a shape of a wall portion of the opening adjusting block 151. Even in this case, because the opening adjusting block 151 is sandwiched between the door check 14 and the stopper portion 13, the opening of the door D can be restricted in the non-step manner.

The shape of the positional restriction member 161 is not limited to a wedge shape as shown in FIG. 15D. The shape of the surface of the positional restriction member 161 that comes in contact with a second surface of the opening adjustment member 151 has only to include a shape that is along the inclination of the second surface. Accordingly, the opening adjusting block 151 can be inhibited from being disoriented or moving due to an impact of the contact of the opening adjusting block 151 with the stopper portion 13. In a case where the positional restriction member 161 is used, and even in a case where the opening adjusting block 151 is not disposed between the door check 14 and the stopper portion 13, the positional restriction member 161 comes to be sandwiched between the door check 14 and the stopper portion 13 when the door D is opened. In this case, the positional restriction member 161 is sandwiched between the door check 14 and the stopper portion 13, and the opening in which the check link 11 is restricted from moving to the outside of the vehicle corresponds to the full opening of the door D.

Similarly to the third embodiment, an opening adjusting block and a housing can be configured such that the housing is provided with a groove portion, that the opening adjusting block is provided with a protrusion, and that the protrusion is engaged with groove portion. In this case, because the opening adjusting block is restricted from moving within the housing by the engagement of the protruding piece and the groove portion, the relative positions of the door check 14 and the opening adjusting block are restricted from being disoriented from each other in a case where the opening adjusting block is disposed on the check link 11. Thus, the opening adjusting block can be disposed between the door check 14 and the stopper portion 13 more precisely. Alternatively, the opening adjusting block may be provided with a groove portion and the block case may be provided with a protrusion. The opening adjusting block and the block case may be provided with the respective groove portions, and a protrusion being engaged with the groove portions can be configured separately.

According to the fifth embodiment, the opening adjusting block 151 is disposed at the upper portion of the check link 11, however, the direction where the opening adjusting block 151 is disposed is not limited to this. The opening adjusting block 151 has only to be sandwiched between the door check 14 and the stopper portion 13, and may be disposed at any positions relative to the check link 11. For example, the opening adjusting block 151 may be disposed at a lateral position or at a lower position of the check link 11. In this case, the housing 160 may also be disposed at any positions. The opening 166 of the housing 160 may be formed as a hole portion through which the check link passes. The movement of the opening adjusting block 151 relative to the check link 11 is not limited to the sliding in the upper-lower directions. A sliding in any directions in accordance with the disposed position of the opening adjusting block 151. Alternatively, the movement of the opening adjusting block 151 relative to the check link 11 may be, for example, a rotation to the check link 11 and a rotation about an axis of the check link 11.

According to the fifth embodiment, similarly to the opening adjusting block 3 of the first embodiment, the opening adjusting block 151 may be configured such that the opening can be adjusted automatically by using, for example, an actuator. In a case where the opening is adjusted manually, the opening adjusting block can be moved using, for example, the actuator.

According to the door checking mechanism 150 of the fifth embodiment, the door check 14 is used as a movement restriction portion restricting the opening adjusting block 151 from moving to the first end portion of the check link 11, the first end portion mounted on the vehicle body B. Alternatively, similarly to the modified example of the third embodiment, a housing can be used for the door checking mechanism 150 of the fifth embodiment as the movement restriction portion. In this case, for example, a groove portion or a protrusion for coming in contact with the opening adjusting block can be provided at the housing. The housing can be configured so as to come in contact with a surface of the opening adjusting block, the surface opposing to a door check.

### Sixth Embodiment

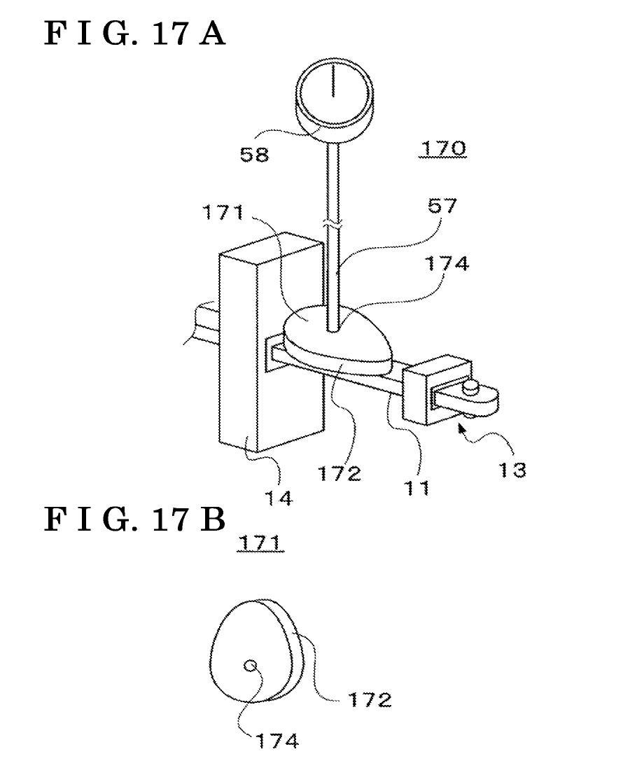

In the fifth embodiment, the opening adjusting block having the wedge shape is described. According to a sixth embodiment, the opening of the door D for the vehicle is adjusted or set at any openings in the non-step manner by the formation the opening adjusting block in a cam shape. FIG. 17A illustrates a door checking mechanism 170 including a cam-shaped opening adjusting block 171. FIG. 17B illustrates the cam-shaped opening adjusting block 171. As shown in FIG. 17A, the door checking mechanism 170 includes the door check 14, the check link 11, the stopper portion 13, the opening adjusting block 171, and an opening adjustment dial 58. The opening adjusting block 171 is disposed at an upper portion of the check link 11. As shown in FIG. 17B, the opening adjusting block 171 is provided with an outer peripheral surface 172 and a hole portion 174 through which, for example, the cable 57, the wire, or the stick member connected to the opening adjustment dial 58 pass. In FIG. 17A, the door D is not illustrated for simplifying the explanation.

The opening adjusting block 171 is formed in the cam shape as shown in FIG. 17B and continuously changes a distance from the rotational center (the hole portion 174) to the outer peripheral surface 172 along the outer peripheral surface 172. According to the sixth embodiment, the hole portion 174 is provided as the rotational center of the opening adjusting block 171. Alternatively, the hole portion 174 may be provided with a rotational center other than the hole portion 174.

The opening adjustment dial 58 may dispose the opening adjusting block 171 between the door check 14 and the stopper portion 13 by moving the opening adjusting block 171 in the upper-lower directions via, for example, the cable 57. Moreover, the opening adjustment dial 58 can rotate the opening adjusting block 171 via a rotational member which is not shown in the drawings. The rotational member may be configured by using, for example, a stick member or a gear, and rotates in response to the operation of the opening adjustment dial 58 to rotate the opening adjusting block 171 being connected to the rotational member. Furthermore, the rotational member maintains the rotational angle of the opening adjusting block 171 until the opening adjusting block 171 is operated by the opening adjustment dial 58. The opening adjustment dial 58 disposes the opening adjusting block 171 between the door check 14 and the stopper portion 13 when being pressed, and can restrict the check link 11 from moving to the outside of the vehicle. Furthermore, the opening adjustment dial 58 may rotate to be able to adjust the opening of the door D by rotating the opening adjusting block 171. A switch for disposing the opening adjusting block 171 between the door check 14 and the stopper portion 13 may be provided in addition to the opening adjustment dial 58, and the opening adjustment dial 58 only adjusts the opening of the door D. According to the sixth embodiment, in a case where the opening adjustment is not performed, the opening adjustment dial 58 is disposed at an upper portion of the check link 11, the position where the opening adjustment dial 58 does not come in contact with the stopper portion 13.

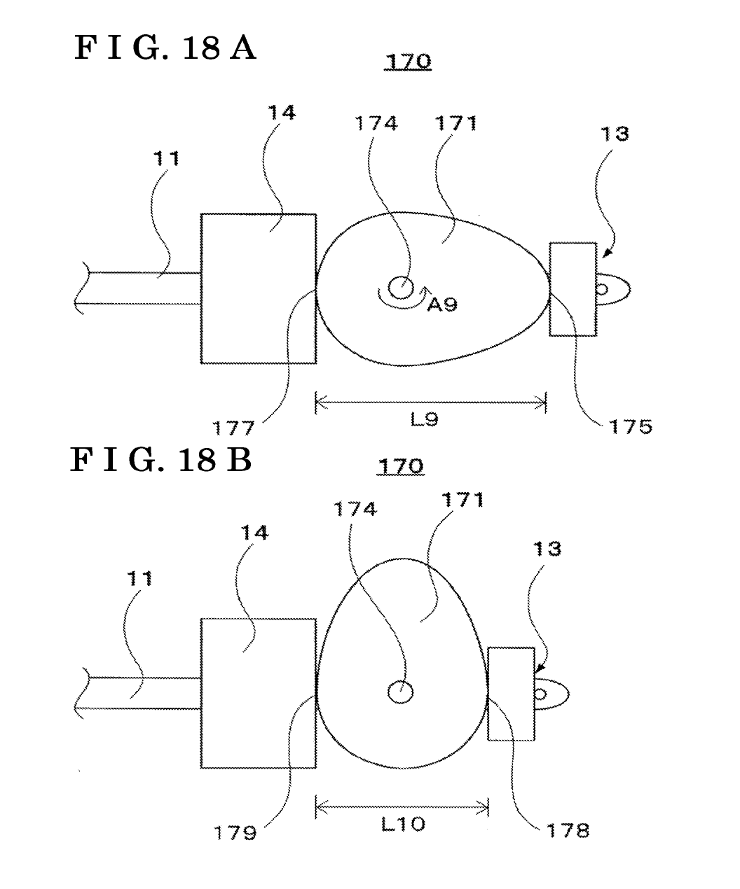

Next, an opening adjustment method of the door D using the opening adjusting block 171 will be explained with reference to FIGS. 18A and 18B. FIG. 18A is a top view of the door checking mechanism 170 in a case where the opening adjusting block 171 is disposed to restrict the opening of the door D at the first opening in which the opening operation of the door D is restricted the most within the adjustable range. FIG. 18B is a top view of the door checking mechanism 170 in a case where the opening adjusting block 171 is disposed to restrict the opening of the door D at the second opening in which the opening operation of the door D is restricted the least within the adjustable range. Here, the adjustable range of the opening of the door D corresponds to a range of the restricted opening (the maximum opening) of the door D, the opening that can be adjusted using the opening adjusting block 171. In FIGS. 18A and 18B, the door D and the opening adjustment dial 58 are not illustrated for simplifying the explanation.

First, in a case where a user does not operate the opening adjustment dial 58, because the opening adjusting block 171 is not disposed between the door check 14 and the stopper portion 13 of the door checking mechanism 170, the door D can be opened to the fully-opened position.

On the other hand, in a case where a user operates the opening adjustment dial 58 to move the opening adjusting block 171 downwardly, the opening adjusting block 171 comes to be disposed between the door check 14 and the stopper portion 13. Thus, in a case where the door D is opened, the opening adjusting block 171 comes to be sandwiched between the door check 14 and the stopper portion 13 to restrict the check link 11 from moving to the first end portion of the check link 11, the first end portion mounted on the vehicle body B. Accordingly, the opening of the door D is restricted. Assuming that a user operates the opening adjustment dial 58 and sets the opening of the door D at the opening (the first opening) in which the opening operation of the door D is restricted the most within the adjustable range, as shown in FIG. 18A, the opening adjusting block 171 rotates in response to the operation of the opening adjustment dial 58, and a portion 175 of the outer periphery surface 172 of the opening adjusting block 171, the portion 175 that has a longest distance from the rotational center to the outer circumferential surface 172, is disposed so as to come in contact with the stopper portion 13. Then, when the door D is opened, the check link 11 moves in the direction where the check link 11 is pulled out of the door D. The opening adjusting block 171 is sandwiched between the door check 14 and the stopper portion 13. In this case, the stopper portion 13 comes in contact with the portion 175 (the second portion) of the outer peripheral surface 172, the portion 175 that has the longest distance from the rotational center to the outer peripheral surface 172. The door check 14 comes in contact with a portion facing the portion 175 of the outer peripheral surface 172, that is, with a portion 177 (the first portion) that faces the portion 175 of the outer peripheral surface 172. Accordingly, the opening adjusting block 171 can restrict the check link 11 from moving to the outside of the door by a distance L9 between the portion 177 and the portion 175 of the opening adjusting block 171, and can restrict the opening of the door D at the first opening that corresponds to the distance L9. In FIG. 18A, the portion 175 that has the longest distance from the rotational center to the outer peripheral surface 172 is disposed so as to come in contact with the stopper portion 13. Alternatively, the portion 175 may be disposed so as to come in contact with the door check 14 to restrict the opening of the door D at the first opening. In both cases, this is because the length of the opening adjusting block 171 being sandwiched between the door check 14 and the stopper portion 13 is unchanged, and the moving distance of the check link 11 being restricted by the opening adjusting block 171 is unchanged.

Next, assuming that the opening adjustment dial 58 is operated to rotate the opening adjusting block 171 in a direction of an arrow A9 shown in FIG. 18A, and that the opening of the door D is set from the first opening to the opening (the second opening) in which the opening operation of the door D is restricted the least within the adjustable range, as shown in FIG. 18B, the opening adjusting block 171 is disposed such that a portion 179 and a portion 178 that have the shortest distances from the rotational center to the outer peripheral surface 172 are sandwiched between the door check 14 and the stopper portion 13. Then, in a case where the door D is opened, the check link 11 moves to the first end portion of the check link 11, the first end portion mounted on the vehicle body B, and the opening adjusting block 171 comes to be sandwiched between the door check 14 and the stopper portion 13. Here, the stopper portion 13 comes in contact with the portion 178 (the second portion) of the outer peripheral surface 172, the portion 178 that has a shortest distance from the outer circumferential surface 172. The door check 14 comes in contact with a portion 179 (the first portion) of the outer peripheral surface 172, the portion 179 that is disposed opposite to the portion 178. Thus, the opening adjusting block 171 restricts the check link 11 from moving to the outside of the door by a distance L10 between the portion 179 and the portion 178 of the opening adjusting block 171. Thus, the opening of the door D can be restricted at the second opening corresponding to the distance L10. In FIG. 18B the opening adjusting block 171 is disposed such that the portion 178 comes in contact with the stopper portion 13. Alternatively, the opening of the door D can be restricted at the second opening by the positioning of the opening adjusting block 171 such that the opening adjusting block 171 rotates in a reverse direction of an arrow A9 and such that the portion 179 comes in contact with the stopper portion 13. In both cases, this is because the length (the distance) of the opening adjusting block 171 that is sandwiched between the door check 14 and the stopper portion 13 is unchanged, and the moving distance of the check link 11 restricted by the opening adjusting block 171 is unchanged.

The method for setting the opening of the door D at the minimum value (the opening in which the opening operation of the door D is restricted the most) of the opening of the door D and at the maximum value (the opening in which the opening operation of the door D is restricted the least) of the opening of the door D within the adjustable range by using the opening adjusting block 171 was explained. According to the door checking mechanism 170 being provided with the opening adjusting block 171 of the sixth embodiment, the opening adjusting block 171 is formed in a cam shape in which the distance from the rotational center to the outer peripheral surface 172 changes continuously along the outer peripheral surface 172. Here, in a case where the opening adjusting block 171 is disposed between the door check 14 and the stopper portion 13, an outer peripheral surface serving as a cam surface in which the distance from the rotational center continuously changes comes in contact with the door check 14 and the stopper portion 13. Thus, because the rotational angle of the opening adjusting block 171 is changed, the distance of the opening adjusting block 171 being sandwiched between the door check 14 and the stopper portion 13 continuously changes. The moving distance of the check link 11 that is restricted continuously changes. Accordingly, because the rotational angle of the opening adjusting block 171 is adjusted, the opening of the door D that is restricted can continuously change. As a result, the opening of the door D can be adjusted in the non-step manner within the adjustable range, that is, can be adjusted as any openings, by the opening adjusting block 171.

According to the sixth embodiment, the adjustable range can be set in accordance with the shape of the opening adjusting block 171. For example, because the distance L9 from the portion 175 that has the longest distance from the rotational center to the outer peripheral surface 172 to the portion 177 that is disposed opposite to the portion 175 is adjusted, the minimum value within the adjustable range may be adjusted. That is, in a case where the distance L9 serves as a distance corresponding to the length between the door check 14 and the stopper portion 13 in a case where the door D is fully closed, the opening of the door D can be adjusted to the opening of the door D in the fully-closed state. Thus, the opening adjusting block can adjust the opening of the door D in the non-step manner up to the opening of the door D in the fully-closed state. Similarly, because the distance L10 between the portion 178 and the portion 179 that have the shortest distances between the rotational center and the outer peripheral surface 172 is adjusted, the maximum value may be adjusted within the adjustable range. The outer peripheral surface 172 that does not pass through the portion 175 being provided between the portion 178 and the portion 179 of the opening adjusting block 171 may be formed so as to include a constant radius from the rotational center. The cam shape of the opening adjusting block 171 is not limited to the shape of the sixth embodiment. For example, the cam shape may continuously change the distance from the rotational center to the outer peripheral surface over almost a round may be formed. In this case, the door checking mechanism may be configured so as to restrict the movement of the opening adjusting block 171 about the rotational center in the moving direction of the check link 11.

The opening adjusting block 171 of the sixth embodiment may be contained within the block case. In this case, because the block case is provided with a groove portion and the opening adjusting block is provided with a protruding piece corresponding to the groove portion, the opening adjusting block can be precisely positioned at a position where the adjustment block comes in contact with the door check 14 and the stopper portion 13. According to the construction, for example, the groove portion may be formed at an upper surface of the block case, and the corresponding protrusion piece may be formed at an upper surface of the opening adjusting block. Alternatively, a groove portion may be provided at the opening adjusting block and a protrusion may be provided at the block case. Alternatively, respective groove portions may be provided at the opening adjusting block and at the block case, and a protrusion engaging with the groove portions may be provided separately.

According to the sixth embodiment, the opening adjusting block 171 is disposed at an upper portion of the check link 11. However, the direction where the opening adjusting block 3 is disposed is not limited to this. The opening adjusting block 171 has only to be disposed so as to be sandwiched between the door check 14 and the stopper portion 13, and may be disposed in any directions relative to the check link 11. For example, the opening adjusting block 171 may be disposed at a lateral position of the check link 11, or at a lower portion of the check link 11. Alternatively, the second opening adjusting block 171 may be disposed at a position facing the first opening adjusting block 171 while sandwiching the check link 11. Accordingly, two of the opening adjusting blocks 171 may be moved in conjunction with each other in response to the operation of the opening adjustment dial 58. In this case, because the two adjusting blocks 171 are used, the check link 11 may be stably restricted from moving to the outside of the door. The movement of the opening adjusting block 171 relative to the check link 11 is not limited to the sliding in the upper-lower directions, and may be a sliding in any directions in accordance with the disposed position of the opening adjusting block 171. The movement of the opening adjusting block 171 relative to the check link 11 may be, for example, a rotation to the check link 11 or a rotation about the axis of the check link 11.

Similarly to the opening adjusting block 3 according to the first embodiment, the opening adjusting block 171 of the sixth embodiment may adjust the opening automatically using, for example, an actuator. Even in a case where the opening is adjusted manually, the opening adjusting block 171 may be moved using, for example, the actuator.

### Seventh Embodiment

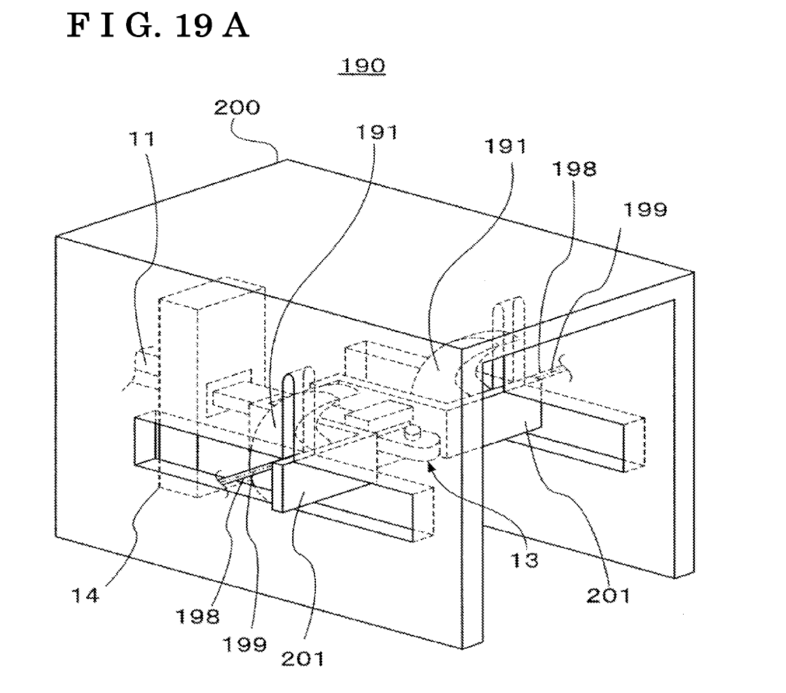

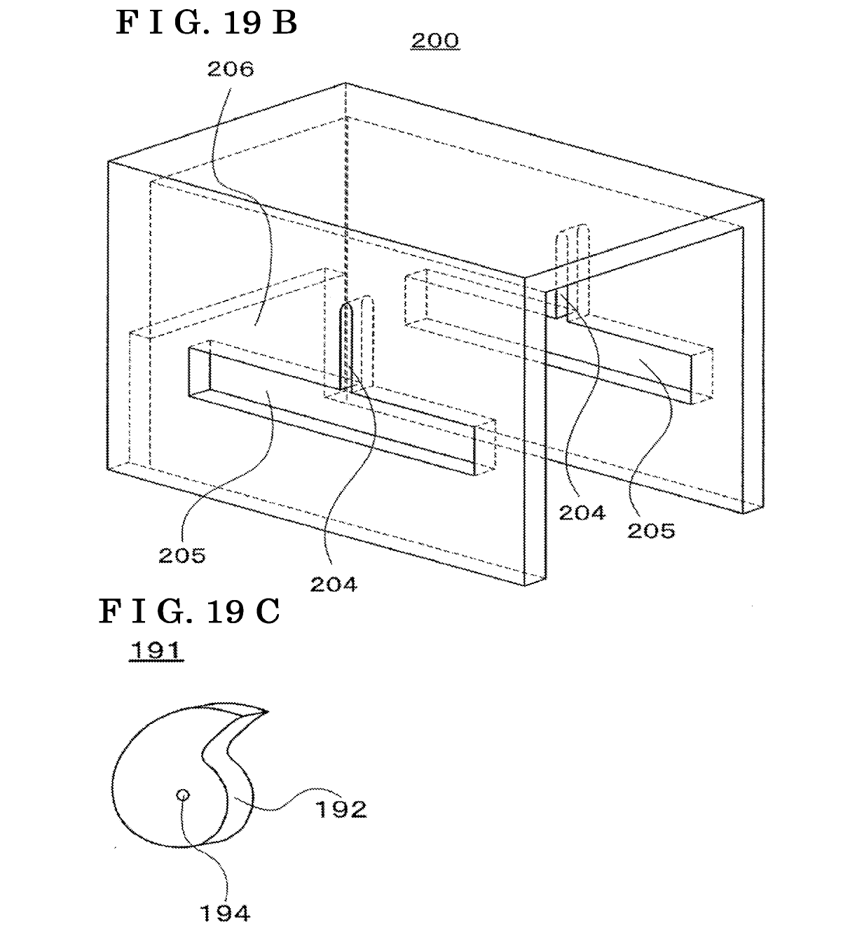

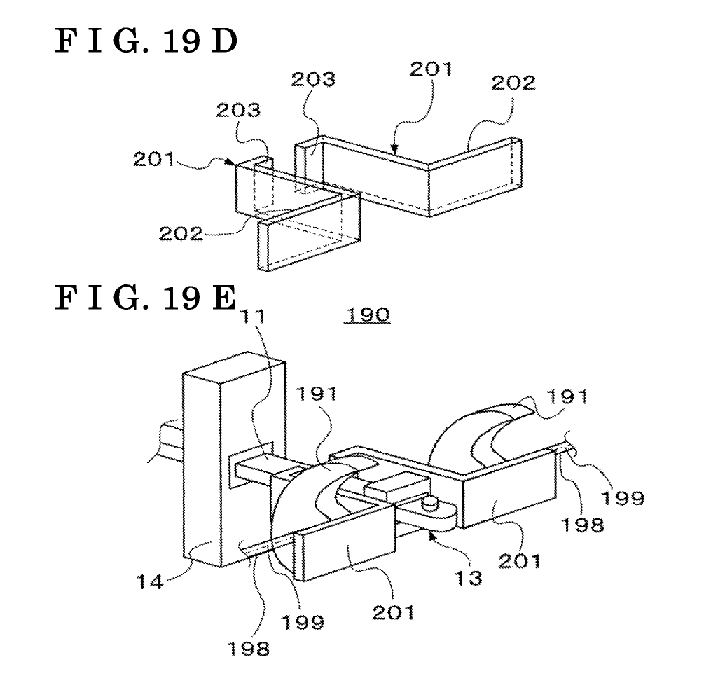

A door checking mechanism 190 according to a seventh embodiment of the present invention will be explained with reference from FIG. 19 through FIG. 22. The door checking mechanism 190 of the seventh embodiment adjusts the opening of the door D in the non-step manner, that is, in any openings, by using cam-shaped opening adjusting blocks 191 being retained at retention members 198, and positional restriction member 201 being in contact with the opening adjusting blocks 191 and the stopper portion 13. FIG. 19A illustrates the door checking mechanism 190 of the seventh embodiment. FIG. 19B illustrates a housing 200. FIG. 19C illustrates the opening adjusting block 191. FIG. 19D illustrates the positional restriction members 201. FIG. 19E illustrates the door checking mechanism 190 in which the housing 190 is not illustrated for explanation. In FIG. 19A, the door D and the opening adjustment dial 58 are not illustrated for simplifying the explanation. Furthermore, the explanation of the opening adjustment dial 58 will not be described because the opening adjustment dial 58 is similar to the opening adjustment dial 58 in the sixth embodiment.

As shown in FIG. 19A, the door checking mechanism 190 includes the door check 14, the check link 11, and the stopper portion 13. The door checking mechanism 190 includes the opening adjusting blocks 191, the retention members 198, the housing 200, and the positional restriction members 201. The opening adjusting block 191 is formed in a cam-shape. The retention member 198 retains the opening adjusting block. The positional restriction member 201 comes in contact with the opening adjusting block 191 and the stopper portion 13. The housing 200 contains the opening adjusting blocks 191, the positional restriction members 201, and the door check 14, and is mounted on the door D for the vehicle via the door checking mechanism 190. As shown in FIG. 19B, the housing 200 includes openings 204 through which the respective retention members 198 retaining the adjustment blocks 191 pass through, openings (guide portions) 205 through which the retention members 198 and the positional restriction members 201 pass through, and an opening 206 through which the check link 11 passes through. As shown in FIG. 19C, the opening adjusting block 191 includes an outer peripheral surface 192 and a hole portion 194 through which the retention member 198 passes, the retention member 198 connected to the opening adjustment dial 58. As shown in FIG. 19D, the positional restriction member 201 includes a first surface 202 being in contact with the opening adjusting block 191 and a second surface 203 coming in contact with the stopper member 13. The positional restriction members 201 are contained within the housing 200 via the openings 205, and are supported at the openings 205. Here, the opening 205 is formed along the moving direction of the check link 11. The positional restriction member 201 may slide along the shape of the opening 205 in the moving direction of the check link 11. The positional restriction member 201 is biased by a biasing member, for example, a spring that is not shown in the drawing in a direction to the stopper portion 13.

According to the seventh embodiment, as shown in FIGS. 19A and 19E, the opening adjusting blocks 191 are disposed one by one at the lateral positions of the check link 11, and come in contact with the stopper portion 13 via the substantially crank-shaped positional restriction members 201. As shown in FIG. 19C, the opening adjusting block 191 is formed in a cam shape that continuously changes the distance from the rotational center 199 to the outer peripheral surface (the cam surface) 192 over almost a round. The opening adjusting block 191 is rotatably retained by the retention member 198 that is made from, for example, a stick member. Two of the opening adjusting blocks 191 that are disposed at the opposing lateral positions of the check link 11 rotate in conjunction with each other. According to the door checking mechanism 190 of the seventh embodiment, the opening adjusting blocks 191 are disposed at the opposing lateral positions of the check link 11. Alternatively, only one of the opening adjusting block 191 may be disposed. In this case, the positioning restriction member 201, the opening 204, and the opening 205 are provided at a side where the opening adjusting block 191 is disposed.

The retention member 198 is connected to the opening adjustment dial 58 via, for example, the wire, cable, or the stick member, and rotates in response to the operation of the opening adjustment dial 58. The retention member 198 retains the opening adjusting block 191 so as to restrict the opening adjusting block 191 from moving to the first end portion of the check link 11, the first end portion being mounted on the vehicle body B, in the moving direction of the check link 11. Here, the retention member 198 retains the opening adjusting block 191 in a cantilever manner. Thus, the opening adjusting block 191 rotates about a rotation shaft 199 in response to the operation of the opening adjustment dial 58 via the retention member 198. The retention member 198 retains the opening adjusting block 191 at a rotation angle in response to the operation of the opening adjustment dial 58. Here, as shown in FIG. 19A, the retention member 198 extends within the housing 200 via the opening 204 or the opening 205 of the housing 200, and retains the opening adjusting block 191 within the housing 200. The retention member 198 may slide in the upper-lower directions relative to the check link 11 along the opening 205 on the basis of the operation of the opening adjustment dial 58, for example, the pressing operation. Thus, in a case where the opening of the door D is not restricted, the opening adjusting block 191 may be disposed at a position where the opening adjusting block 191 does not disturb the movement of the check link 11 by the operation of the opening adjustment dial 58 to move the retention member 198 to an upper portion of the check link 11. Thus, in a case where the opening of the door D is not restricted, the opening adjusting block 191 does not restrict the check link 11 from moving, and may open the door D up to the full opening. Here, because the positioning restriction member 201 is sandwiched between the door check 14 and the stopper portion 13, the opening in which the positional restriction member 201 restricts the check link 11 from moving to the outside of the door corresponds to the full opening of the door D. Furthermore, as mentioned above, because the positional restriction member 201 is biased in the direction to the stopper portion 13, the positional restriction member 201 moves in response to the movement of the stopper portion 13 even in a case where the door D opens up to the fully-open position after the opening adjusting block 191 is disposed at a position where the opening adjusting block 191 does not restrict the check link 11 from moving. Thus, in a case where the door D is opened up to the full open position, the positional restriction member 201 may be prevented from being maintained at the position where the positional restriction member 201 comes in contact with the door check 14, and the positional restriction member 201 may be prevented from disturbing the sliding of the opening adjusting block 191. The retention member 198 is slidable in the upper-lower direction, however, does not move in the moving direction of the check link 11 by any restriction member fixed at the door D.

The positional restriction member 201 is formed in a substantially crank shape as shown in FIG. 19D, and is disposed between the opening adjusting block 191 and the stopper portion 13. The positional restriction member 201 may come in contact with the opening adjusting block 191 at the first surface 202 being provided at one end portion that is disposed in the vicinity of the opening adjusting block 191. The positional restriction member 201 may come in contact with the stopper portion 13 at the second surface 203 being provided at the other end portion that is disposed in the vicinity of the check link 11. Because the positional restriction member 201 is biased in the moving direction of the check link 11 to the inside of the door D, that is, in a direction to the stopper portion 13 by a biasing member, for example, a spring that is not shown in the drawing, the positional restriction member 201 comes in contact with the stopper portion 13 at the second surface 203. The positional restriction member 201 may move in the moving direction of the check link 11 in response to the movement of the stopper portion 13 by coming in contact with the stopper portion 13 at the second surface 203. Because the opening adjusting block 191 is retained at the rotational angle being set by the retention member 198, the opening adjusting block 191 does not rotate even though the opening adjusting block 191 comes in contact with the first surface 202. As mentioned above, because the retention member 198 does not move in the moving direction of the check link 11, the opening adjusting block 191 that is retained by the retention member 198 does not move in the moving direction of the check link 11.

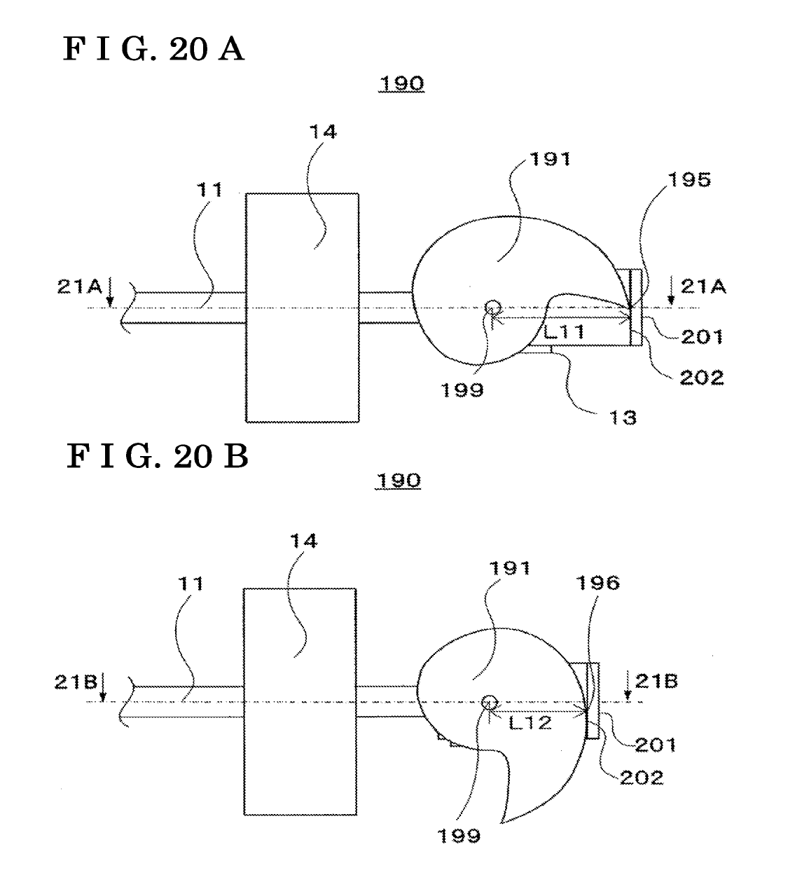

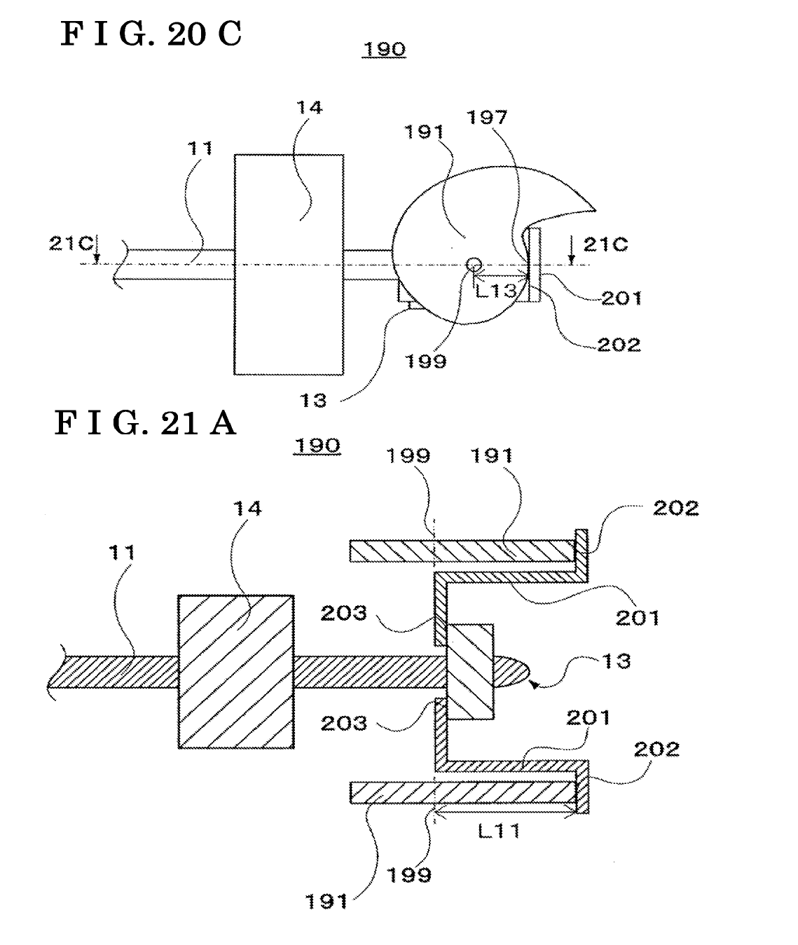

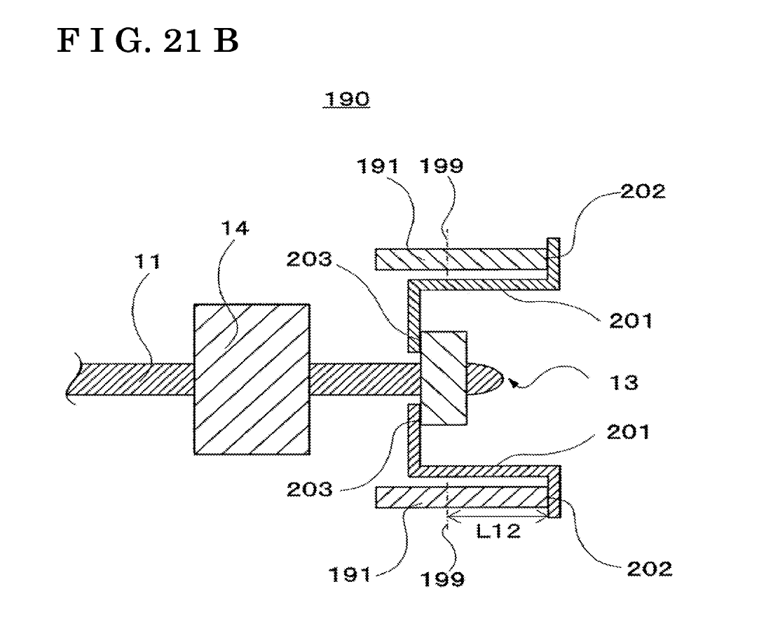

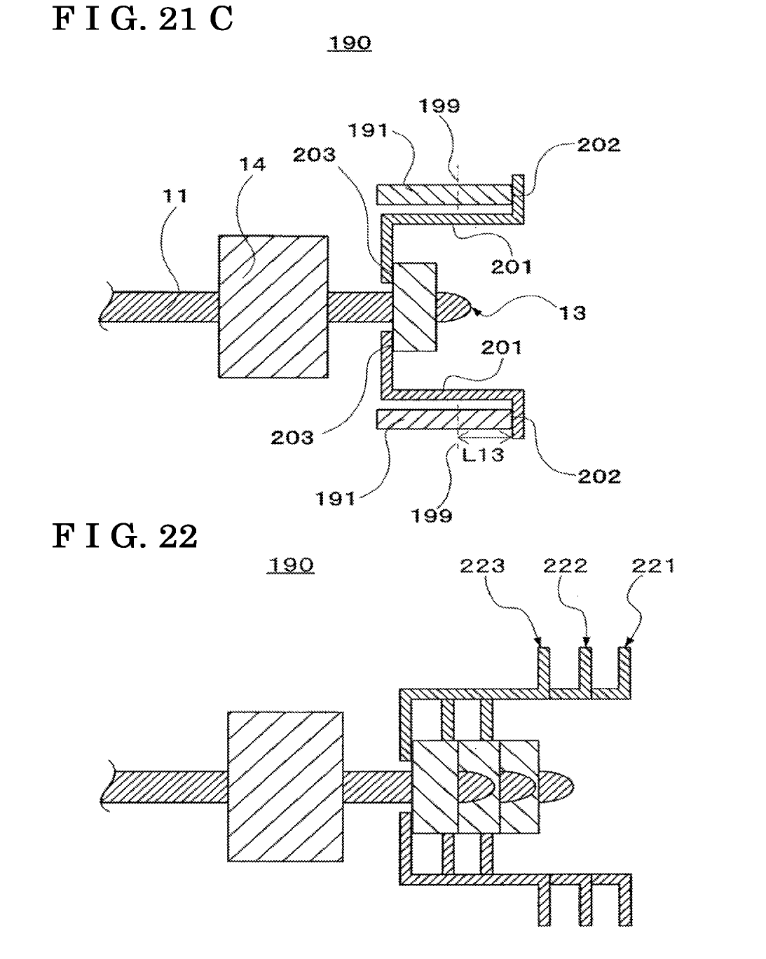

Next, an adjusting method of the opening of the door D by the check link 190 of the seventh embodiment will be explained with reference to FIG. 20A through FIG. 22. FIG. 20A illustrates a side view of the door checking mechanism 190 in a case where the opening of the door D is set at the opening (the first opening) in which the opening movement of the door D within the adjustable range is restricted the most. FIG. 20B illustrates a side view of the door checking mechanism 190 in a case where the opening of the door D is set at the middle opening (the second opening) within the adjustable range. FIG. 20C illustrates a side view of the door checking mechanism 190 in a case where the opening of the door D is set at the opening (the third opening) in which the opening operation of the door D within the adjustable range is restricted the least. FIG. 21A illustrates a cross sectional view taken along line 21A-21A shown in FIG. 20A. FIG. 21B illustrates a cross sectional view taken along line 21B-21B shown in FIG. 20B. FIG. 21C illustrates a cross sectional view taken along line 21C-21C shown in FIG. 20C. FIG. 22 illustrates a view explaining the respective positions of the positional restriction member 201 and the stopper portion 13, the respective positions corresponding to the first, second, and third openings. Here, the adjustable range corresponds to a range of the restricted opening (the maximum opening) of the door D that is adjusted and restricted by using the opening adjusting block 151. In FIG. 20A through FIG. 22, the door D, the opening adjustment dial 58, the retention member 198, and the housing 200 are not illustrated for simplifying the explanation. The opening adjusting block 191 is not illustrated for explanation in FIG. 22. Because two of the opening adjusting blocks 191 that are disposed at the lateral positions of the check link 11 operate the same movement in conjunction with each other, hereinafter, only the movement of the opening adjusting block 191 that is disposed at the right when seen from the door check 14 will be explained.

First, a case where the opening of the door D is set at the opening (the first opening) in which the opening operation of the door D is restricted the most by a user who operates the opening adjustment dial 58 will be explained with reference to FIGS. 20A and 21A. In a case where the opening of the door D is set at the first opening, as shown in FIG. 20A, the opening adjusting block 191 rotates in response to the operation of the opening adjustment dial 58. A portion 195 of the outer peripheral surface 192 including a longest distance L11 from the rotational center (the rotational shaft 199) of the opening adjusting block 191 is disposed at a position where the portion 195 comes in contact with the first surface 202 of the positional restriction member 201. Thus, in a case where the door D is opened, the first surface 202 comes in contact with the opening adjusting block 191 at a position away from the rotational center of the opening adjusting block 191 by the distance L11 in a direction away from the door check 14 in the moving direction (the longitudinal direction) of the check link 11. The second surface 203 of the positional restriction member 201 comes in contact with the stopper portion 13. As a result, the opening adjusting block 191 comes in contact with the stopper portion 13 via the positional restriction member 201, and restricts the check link 11 from moving to the first end portion of the check link 11, the first end portion mounted on the vehicle body B. Thus, the opening adjusting block 191 may restrict the opening of the door D at the first opening corresponding to the distance L11.

Next, a case where the opening of the door D is set at the middle opening (the second opening) within the adjustable range by a user who operates the opening adjustment dial 58 will be explained with reference to FIGS. 20B and 21B. In a case where the opening of the door D is set at the second opening, as shown in FIG. 20B, the opening adjusting block 191 rotates in response to the operation of the opening adjustment dial 58, and a portion 196 of the outer peripheral surface 192 including a distance L12 from the rotational center of the opening adjusting block 191 is disposed at a position where the portion 196 comes in contact with the first surface 202 of the positional restriction member 201. Here, the distance L12 corresponds to a middle distance between the longest distance L11 and a shortest distance L13 from the rotational center of the opening adjusting block 191. In a case where the door D is opened, the first surface 202 comes in contact with the opening adjusting block 191 at a position away from the rotational center of the opening adjusting block 191 by the distance L12 in a direction away from the door check 14 in the moving direction of the check link 11. The second surface 203 of the positional restriction member 201 comes in contact with the stopper portion 13. As a result, the opening adjusting block 191 comes in contact with the stopper portion 13 via the positional restriction member 201, and restricts the check link 11 from moving to the first end portion of the check link 11, the first end portion mounted on the vehicle body B. Thus, the opening adjusting block 191 may restrict the opening of the door D at the second opening that corresponds to the distance L12.

Lastly, a case where the opening of the door D is set at the opening (the third opening) in which the opening operation of the door D is restricted the least by a user who operates the opening adjustment dial 58 will be explained with reference to FIGS. 20C and 21C. In a case where the opening of the door D is set at the third opening, as shown in FIG. 20C, the opening adjusting block 191 rotates in response to the operation of the opening adjustment dial 58, and a portion 197 of the outer peripheral surface 192 including the shortest distance L13 from the rotational center of the opening adjusting block 191 is disposed at a position where the portion 197 comes in contact with the first surface 202 of the positional restriction member 201. Thus, in a case where the door D is opened, the first surface 202 of the positional restriction member 201 comes in contact with the opening adjusting block 191 at a position away from the rotational center of the opening adjusting block 191 by the distance L13 in the direction away from the door check 14 in the moving direction of the check link 11. The second surface 203 of the positional restriction member 201 comes in contact with the stopper portion 13. As a result, the opening adjusting block 191 comes in contact with the stopper portion 13 via the positional restriction member 201, and restricts the check link 11 from moving to the first end portion of the check link 11, the first end portion mounted on the vehicle body B. Thus, the opening adjusting block 191 may restrict the opening of the door D at the third opening that corresponds to the distance L13.

FIG. 22 illustrates respective positions of the positional restriction member 201 and the stopper portion 13 that are disposed side by side shown in FIG. 21A through FIG. 21C. In FIG. 22, a position of the positional restriction member 201 and the stopper portion 13 at the first opening shown in FIG. 21A corresponds to a position 221. A position of the positional restriction member 201 and the stopper portion 13 at the second opening shown in FIG. 21B corresponds to a position 222. A position of the positional restriction member 201 and the stopper portion 13 at the third opening shown in FIG. 21C corresponds to a position 223. As shown in FIG. 22, in a case where the opening of the door D is restricted at the first opening, the stopper portion 13 is disposed at the position 221 away from the door check 14. In a case where the opening of the door D is restricted at the third opening, the stopper portion 13 is disposed at the position 223 that is close to the door check 14. In a case where the opening of the door D is restricted at the second opening, the stopper portion 13 is disposed at the position 222 that is disposed between the position 221 and the position 223. Thus, because the opening adjusting block 191 rotates, a position restricting the positional restriction member 201 and the stopper portion 13 from moving, that is, a position restricting the check link 11 from moving, may be changed. Thus, the opening of the door D can be adjusted.

Hereinabove, the method setting the opening of the door D at a minimum value (the most restricted opening of the opening operation of the door D), at a middle value (the middle opening) and at a maximum value (the least restricted opening of the opening operation of the door D) within the adjustable range is explained. Here, as mentioned above, the opening adjusting block is formed in a cam shape continuously changing the distance from the rotational center (the rotational shaft 199) to the outer peripheral surface 192 along the outer peripheral surface 192 over almost a round. Thus, the position of the positional restriction member 201 coming in contact with the opening adjusting block 191 continuously changes by the change of the rotational angle of the opening adjusting block 191. The moving distance of the check link 11 that is restricted by the positional restriction member 201 continuously changes. Thus, the opening of the door D may continuously changes by the opening adjusting block 191. Accordingly, because the rotational angle of the opening adjusting block 191 is adjusted, the opening of the door D may be adjusted in the non-step manner within the adjustable range, that is, may be adjusted to any openings within the adjustable range.

As such, the door checking mechanism 190 of the seventh embodiment includes the door check 14, the check link 11, and the stopper portion 13. The door check 14 is fixed at the door D for the vehicle. The check link 11 includes the first end portion that is rotatably mounted on the vehicle body B and extends within the door D for the vehicle. The stopper portion 13 is provided at the second end portion of the check link 11 extending within the door D. The check link 11 may move in the longitudinal direction of the check link 11 relative to the door check 14. Furthermore, the door checking mechanism 19 includes the opening adjusting block 191, the retention member 198 (the movement restriction portion) retaining the opening adjusting block 191 and the positional restriction member 201. The retention member 198 is fixed at the door D so as not to move in the moving direction of the check link 11 by any restriction member. The check link 11 may move in the longitudinal direction of the check link 11 relative to the retention member 198. The retention member 198 restricts the opening adjusting block 191 from moving to the first end portion of the check link 11, the first end portion being mounted on the vehicle body B, in the moving direction of the check link. Along with that, the retention member 198 rotatably retains the opening adjusting block 191. The retention member 198 restricts the opening adjusting block 191 from moving to the first end portion of the check link 11, the first end portion mounted on the vehicle body B, by coming in contact with the opening adjusting block 191 at the hole portion 194 (the first portion) that corresponds to the rotational center of the opening adjusting block 191. Here, the opening adjusting block 191 restricts the check link 11 from moving to the first end portion of the check link 11, the first end portion mounted on the vehicle body B, by coming in contact with the stopper portion 13 via the positional restriction member 201. Thus, the opening of the door D may be adjusted by the opening adjusting block 191. The opening adjusting block 191 is formed in the cam shape continuously changing the distance from the rotational center to the outer peripheral surface 192 (the cam surface) along the outer peripheral surface 192. Thus, the opening adjusting block 191 may restrict the check link 11 from moving to the first end portion of the check link 11, the first end portion mounted on the vehicle body B, in the moving direction of the check link 11 in accordance with the distance from the rotational center to the portion (the second portion) of the outer peripheral surface 192 that comes in contact with the positional restriction member 201. Thus, the opening adjusting block 191 may restrict the opening of the door D at the opening corresponding to the distance. Thus, because the opening adjusting block 191 is rotated to change the distance from the rotational center to the portion of the outer peripheral surface 192 that comes in contact with the positional restriction member 201, the opening of the door D may be adjusted in the non-step manner, that is, adjusted to the any openings in response to the distance within the adjustable range. Moreover, in a case where the opening is set or restricted by the opening adjusting block, the door D is only restricted from opening to the opening or more than the opening. Thus, the door D may be desirably opened and closed within a range up to the opening that is restricted. According to the seventh embodiment, the door checking mechanism 190 includes the housing 200 that is provided with the opening portion 205 (the guide portion) slidably supporting the positional restriction member 201 in the moving direction of the check link 11. Because the movement of the positional restriction member 201 may be guided by the housing 200, the positional restriction member 201 is restricted from being disoriented based on the movement of the check link 11.

According to the seventh embodiment, the adjustable range may be set in accordance with the position and the shape of the opening adjusting block 191. For example, because the opening adjusting blocks 191 are displaced from each other in the moving direction of the check link 11, the maximum and the minimum values that are adjustable may be set. Alternatively, the maximum value of the adjustable opening may be set by the change of the shape of the opening adjusting block 191 such that the distance L13 of the opening adjusting block 191 is reduced. Similarly, the minimum value of the adjustable opening may be set by the change of the shape of the opening adjusting block 191 such that the distance L11 of the opening adjusting block 191 is enlarged.

According to the seventh embodiment, the opening adjusting block 191 is formed in the cam shape including the cam surface continuously changing the distance from the rotational center to the outer peripheral surface 192 over almost a round, however, the cam shape of the opening adjusting block is not limited to this. The cam shape of the opening adjusting block 191 has only to include a cam surface continuously changing from a rotational center to an outer peripheral surface at a portion of the outer peripheral surface, and, for example, the opening adjusting block 191 may be formed in a substantially egg-shape.

Furthermore, the positional restriction member 201 corresponds to the substantially crank-shaped member, however, the shape of the positional restriction member is not limited to this. The positional restriction member has only to include a shape that restricts the check link 11 from moving to be pulled out by coming in contact with the opening adjusting block 191 at one portion and by coming in contact with the stopper portion 13 at the other portion. Thus, the shape of the positional restriction member may be formed in a linear shape, a wave shape, and a z-shape, for example.

According to the seventh embodiment, the opening adjusting block 191 and the positional restriction member 201 are disposed at the lateral positions of the check link 11, that is, along the lateral direction of the check link 11. Alternatively, the opening adjusting block 191 and the positional restriction member 201 may be disposed along any directions relative to the check link 11, for example, in the upper-lower directions relative to the check link 11.

The retention member 198 and the opening adjusting block 191 move downwardly in response to the operation of the opening adjustment dial 58, that is, moves to be close to the check ink 11. Thus, the opening adjusting block 191 is disposed at the position where the opening adjusting block 191 comes in contact the positional restriction member 201. However, a direction where the opening adjusting block 191 approaches the check link 11 may correspond to any directions in accordance with the respective disposed positions of the opening adjusting block 191 and the positional restriction member 201 relative to the check link 11. For example, in a case where the opening adjusting block 191 and the positional restriction member 201 are disposed along the upper-lower directions relative to the check link 11, the door checking mechanism 190 can be configured such that the opening adjusting block 191 moves in the right direction or in the left direction to approach the check link 11. In this case, the door checking mechanism 190 may be configured such that the opening adjusting blocks 191 move in the upper direction or in the lower direction, that is, the direction where the opening adjusting blocks 191 sandwich the check link 11 to approach the check link 11. The relative movements of the retention member 198 and of the opening adjusting block 191 relative to the check link 11 may be a sliding or a rotation in any directions other than the moving direction of the check link 11, or may be a rotation relative to the axis of the check link 11.

The opening adjusting block 191 of the seventh embodiment, similarly to the opening adjusting block 3 of the first embodiment, may adjust the opening automatically by, for example, an actuator. In a case where the opening is adjusted manually, the opening adjusting block may move by, for example, the actuator.

By having a configuration in which the opening adjusting block 191 may directly come in contact with the stopper portion 13, similarly to the seventh embodiment, the opening of the door D may be restricted in the non-step manner without using the positional restriction member 201. In this case, the opening 205 does not have to be provided at the housing 200.

The shape of the opening adjusting block is not limited to the cam shape. The opening adjusting block has only to be retained by the retention member so as not to move in the moving direction of the check link 11, and has only to be able to come in contact with the positional restriction member 201 or the stopper portion 13. Accordingly, the opening adjusting block may restrict the check link 11 from moving to the outside of the door and may restrict the opening of the door D. Thus, similarly to the first embodiment, for example, the opening adjusting block may be formed in a shape shown in FIG. 14, and may include a step with any stages. In this case, because the opening adjusting block is retained by the retention member so as to be able to move in the upper-lower directions, and because the stepped surface of the opening adjusting block comes in contact with the positional restriction member or the stopper portion 13, the opening of the door D may be restricted in accordance with the step. Moreover, the opening adjusting block may be formed in a shape including an inclination surface having a predetermined angle relative to the stopper portion. In this case, because the opening adjusting block is retained by the retention member so as to be movable in the upper-lower directions, and because the inclination surface comes in contact with the positional restriction member or the stopper portion 13, the opening of the door D may be restricted in the non-step manner, similarly to the seventh embodiment. The direction moving the opening adjusting block is not limited to the upper-lower directions, and may be any directions where the opening adjusting block may move to come in contact with the positional restriction member 201 or the stopper portion 13. For example, the opening adjusting block may move in the right-left directions to come in contact with the positioning restriction member 201 or the stopper portion 13. The movement of the opening adjusting block relative to the check link 11 is not limited to the sliding, and may be, for example, a rotation relative to the check link 11, or a rotation relative to the axis of the check link 11.

According to the seventh embodiment, in a case where the opening adjusting block 191 adjusts the opening of the door D, the opening adjusting block 191 comes in contact with the positional restriction member 201 in response to the operation of the opening adjustment dial 58. Alternatively, the door checking mechanism may be configured such that the positional restriction member 201 moves in response to the operation of the opening adjustment dial 58, and is disposed at a position where the positional restriction member 201 comes in contact with the stopper portion 13 without moving the opening adjusting block 191. For example, the door checking mechanism may be configured such that the positional restriction member 201 is connected to the opening adjustment dial 58 via, for example, the wire, the cable, or the stick member, and the positional restriction member 201 is disposed at a position where the positional restriction member 201 comes in contact with the stopper portion 13 in response to the operation of the opening adjustment dial 5, for example, the pressing operation.

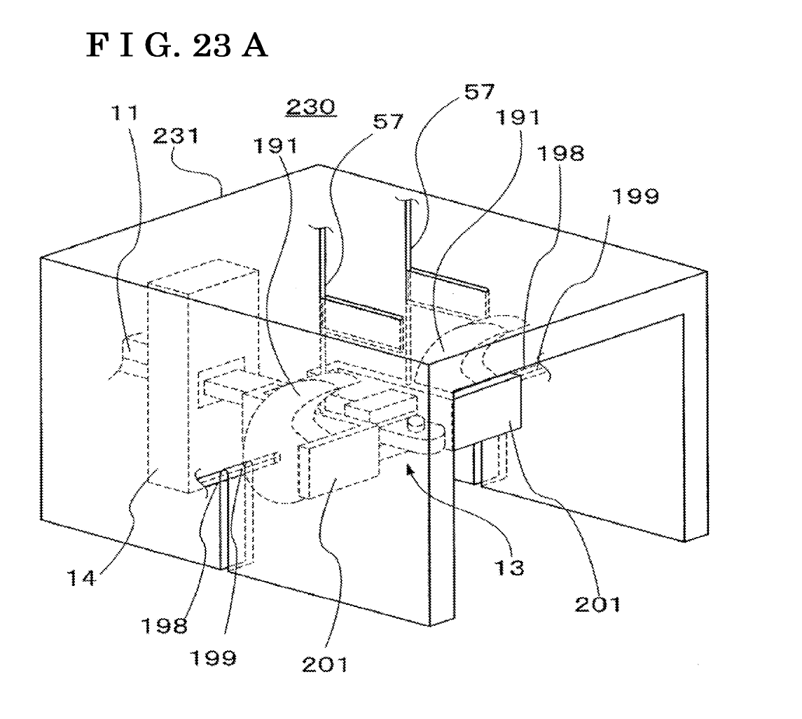

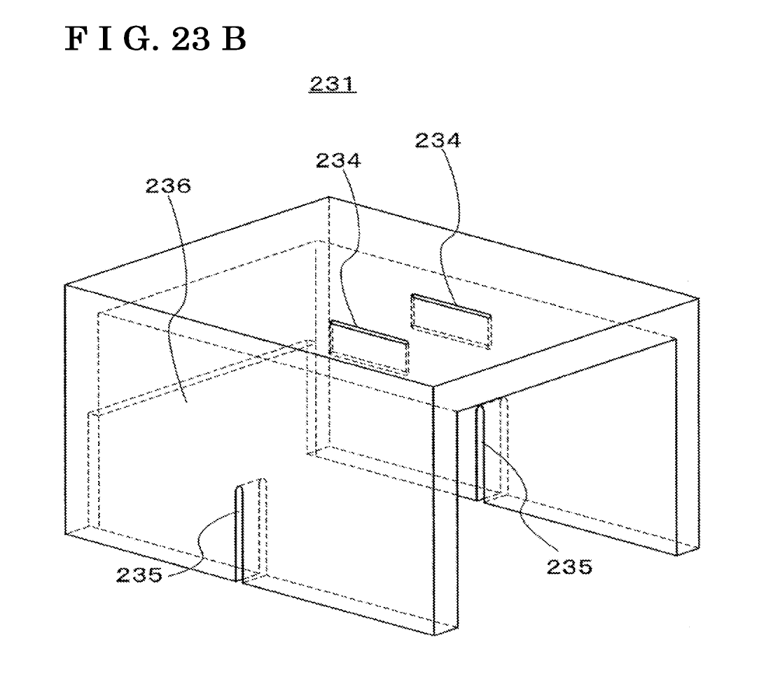

A door checking mechanism 230 of this case will be explained with reference to FIGS. 23A and 23B. FIG. 23A illustrates a modified example of the door checking mechanism 190, and the door checking mechanism 230 being disposed at the position where the positional restriction member 201 comes in contact with the stopper portion 13 instead of the opening adjusting block 191 in a case where the opening of the door D is adjusted. FIG. 23B illustrates a housing 231. In FIG. 23A, the door D and the opening adjustment dial 58 are not illustrated for simplifying the explanation. Because the door checking mechanism 230 is similar to the door checking mechanism in the seventh embodiment other than that the positional restriction member 201 is disposed at a position where the positional restriction member 201 comes in contact with the stopper portion 13 in response to the operation of the opening adjustment dial 58, the differential point will be explained.

In this case, as shown in FIG. 23A, the positional restriction member 201 is connected to the opening adjustment dial 58 via, for example, the cable 57 and is able to move in the upper-lower directions in response to the operation of the opening adjustment dial 58, for example, the pressing operation. As shown in FIG. 23B, the housing 231 is provided with openings 234 through which, for example, the cables 57 pass at an upper surface of the housing 231 instead of the opening 205. The opening 234 is formed along the moving direction of the check link 11. In a case where the positional restriction member 201 moves in the moving direction of the check link 11, the cable 57 may move along the opening 234. Furthermore, the housing 231 is provided with groove portions 235 through which the retention members 198 pass, and an opening 236 through which the check link 11 passes. According to this configuration, the positional restriction member 201 may move to the upper portion of the check link 11 and may be disposed at a position where the positional restriction member 201 does not disturb the movement of the stopper portion 13 by the operation of the opening adjustment dial 58, for example, the pressing operation. Thus, in a case where the opening of the door D is not adjusted, the door D may be opened up to the full position by the disposed position of the positional restriction member 201 at the position where the positional restriction member 201 does not disturb the movement of the stopper portion 13. Similarly to the moving direction of the opening adjusting block 191 at the door checking mechanism 190, the moving direction of the positional restriction member 201 may be any directions in accordance with the respective disposed positions of the opening adjusting block 191 and of the positional restriction member 201. According to this configuration, in a case where the opening adjustment is not performed, because the positional restriction member 201 is not sandwiched between the door check 14 and the stopper portion 13, the position in which the door check 14 and the stopper portion 13 come in contact with each other corresponds to the full open position of the door D.

The respective shapes of the housing 200 and the housing 231 are not limited to the above-described shapes. The opening 206 of the housing 200 and the opening 236 of the housing 231 have only to be openings through which the check link 11 may pass. According to the seventh embodiment and the modified example of the seventh embodiment, each of the housing 200 and the housing 231 are disposed so as to contain, for example, the opening adjusting block 191 from the upper portion of the check link 11. Alternatively, each of the housing 200 and the housing 231 may contain, for example, the opening adjusting block 191 from the lower portion of the check link 11. In a case where the housing 231 is disposed at the lower portion of the check link 11, the housing 231 does not have to be provided with the openings 234 through which, for example, the cables 57 for moving the positional restriction member 201. Each of the housing 200 and the housing 231 contains the door check 14. Alternatively, each of the housing 200 and the housing 231 may be integrally formed with the door check 14.

Hereinabove, the present invention has been explained with reference to the embodiments, however, is not limited to the aforementioned embodiments. Modified invention and an invention equivalent of the present invention are included in the present invention within the limits that they are not contrary to the intention of the present invention. The aforementioned embodiments and the modified examples may be combined with one another appropriately within the limits that they are not contrary to the intention of the present invention.

This application is for claiming the priority right of JP2013-235061 filed on Nov. 13, 2013, and corresponds to a part of the application by the extraction of the contents of JP2013-235061.

### EXPLANATION OF REFERENCE NUMERALS

3, 7, 9, 110, 141, 151, 171, 191: opening adjusting block, 10, 30, 70, 90, 150, 170, 190: door checking mechanism, 11: check link, 12: bracket, 13: stopper portion, 14: door check (movement restriction portion), 21, 103: hinge shaft, 31, 71: recess, 32: first leg portion, 33: second leg portion, 34, 74, 94, 107, 113, 144, 154, 174, 194, 204: hole portion, 35, 75: first-side surface (second portion), 36, 77: second-side surface (third portion), 37: third-side surface (first portion), 51, 53, 55, 58: opening adjustment dial, 52: index line, 54: indicator of door for vehicle, 56: display device, 57: cable, 61, 81: ECU, 62: ranging sensor, 63, 83: block drive circuit, 64, 84: vehicle sensor, 78: button, 85: latch fit sensor, 91: protrusion, 92: block case (movement restriction portion, retention member), 93: groove portion, 95: first opening, 96: second opening, 97: spring, 98, 108: opening adjusting device, 101: vehicle body-side mounting piece, 102: door-side mounting piece, 104, 160, 200, 230: housing (mount member), 105: hollow portion, 106: fitting recess, 111: first-step surface, 112: second-step surface, 145: first surface (second portion), 146: second surface (third portion), 147: third surface (first portion), 155: first surface (second portion), 157: second surface (first portion), 172, 192: outer peripheral surface, 198: retention member, 199: rotational shaft, 201: positional restriction member, 905: first surface (second portion), 906: second surface (third portion), 907: third surface (first portion), D: door, DR: door panel, H: hinge, OP: outer panel, v: vehicle

1. An opening adjusting device adjusting an opening of a door for a vehicle, the opening adjusting device being used at a door checking mechanism including a movement restriction portion configured to be fixed at the door for the vehicle, the door checking mechanism being provided with a check link including a first end portion being rotatably mounted on a vehicle body, the check link extending at an inside of the door for the vehicle, the check link being movable in a longitudinal direction of the check link relative to the movement restriction portion relatively, the door checking mechanism including a stopper portion being provided at a second end portion of the check link extending at the inside of the door for the vehicle, comprising:
an opening adjusting block including a first portion and a second portion having a predetermined distance from the first portion in a moving direction of the check link; and
the movement restriction portion; wherein
the movement restriction portion restricts the opening adjusting block from moving to the first end portion of the check link by coming in contact with the first portion; and in a case where the movement restriction portion restricts the opening adjusting block from moving to the first end portion of the check link, the opening adjusting block restricts the check link from moving to the first end portion of the check link by a contact of the second portion with the stopper portion.

2. The opening adjusting device according to claim 1, wherein the movement restriction portion is a retention member retaining the opening adjusting block.

3. The opening adjusting device according to claim 1, wherein the movement restriction portion is a door check.

4. The opening adjusting device according to claim 1, wherein
the opening adjusting block further includes a third portion having a distance from the first portion, the distance shorter than a distance between the first portion and the second portion; and
in a case where the movement restriction portion restricts the opening adjusting block from moving to the first end portion of the check link, the opening adjusting block restricts the check link from moving to the first end portion of the check link by a contact of one of the second portion and the third portion with the stopper portion.

5. The opening adjusting device according to claim 1, wherein in a case where the door for the vehicle is in a fully-closed position, a distance between the first portion and the second portion corresponds to a distance between a first area of the movement restriction portion, the first area coming in contact with the first portion, and a second area of the stopper portion, the second area coming in contact with the second portion.

6. The opening adjusting device according to claim 1, wherein the second portion is formed as an inclination surface having a predetermined angle relative to the stopper portion.

7. The opening adjusting device according to claim 1, wherein
the opening adjusting block is formed in a cam shape; and
the second portion corresponds to a cam surface in which a distance from a rotational center of the opening adjusting block continuously changes.

8. The opening adjusting device according to claim 1, wherein
the opening adjusting block is connected to a dial;
the movement restriction portion restricts the opening adjusting block from moving to the first end portion of the check link in response to an operation of the
dial, the opening adjusting block being disposed at a position where the opening adjusting block comes in contact with the stopper portion; and
the dial is provided with a display device including one of a liquid crystal display and an organic electroluminescence display.

9. The opening adjusting device according to claim 1, wherein the movement restriction portion restricts the opening adjusting block from moving to the first end portion of the check link in accordance with an obstacle being positioned at a lateral position of the door for the vehicle, the opening adjusting block being disposed at the position where the opening adjusting block comes in contact with the stopper portion.

10. The opening adjusting device according to claim 1, wherein the movement restriction portion restricts the opening adjusting block from moving to the first side portion of the check link, and the opening adjusting block being disposed at the position where the opening adjusting block comes in contact with the stopper portion while the vehicle is running.

11. The opening adjusting device according to claim 2, wherein
the retention member includes a groove portion;
the opening adjusting block includes a protruding piece being engaged with the groove portion; and
the opening adjusting block is retained by the retention member by an engagement of the protrusion engage and the groove portion.

12. The opening adjusting device according to claim 2, further comprising:
a positional restriction member being slidable in a moving direction of the check link; wherein
the retention member includes a guide portion supporting the positional restriction member; and
in a case where the retention member restricts the opening adjusting block from moving to the first end portion of the check link, the opening adjusting block restricts the check link from moving to the first end portion of the check link by coming in contact with the stopper portion via the positional restriction member being supported by the guide portion of the retention member.

13. A door checking mechanism comprising:
movement restriction portion configured to be fixed at a door for a vehicle;
a check link including a first end portion being rotatably mounted on a vehicle body, the check link extending at an inside of the door for the vehicle, the check link being movable in a longitudinal direction of the check link relative to the movement restriction portion relatively;
a stopper portion being provided at a second end portion of the check link extending at the inside of the door for the vehicle; and
an opening adjusting block including a first portion and a second portion having a predetermined distance from the first portion in a moving direction of the check link; wherein
the movement restriction portion restricts the opening adjusting block from moving to the first end portion of the check link by coming in contact with the first portion; and
in a case where the movement restriction portion restricts the opening adjusting block from moving to the first end portion of the check link, the opening adjusting block restricts the check link from moving to the first end portion of the check link by having the second portion come in contact with the stopper portion.

14. An opening adjusting block adjusting an opening of a door for a vehicle, the opening adjusting block being used at a door checking mechanism including a movement restriction portion configured to be fixed at the door for the vehicle, the opening adjusting block being provided with a check link including a first end portion being rotatably mounted on a vehicle body, the check link extending at an inside of the door for the vehicle, the check link being movable in a longitudinal direction of the check link relative to the movement restriction portion relatively, the opening adjusting block including a stopper portion being provided at a second end portion of the check link, comprising:
a first portion; and
a second portion having a predetermined distance from the first portion in a moving direction of the check link; wherein
the movement restriction portion restricts the opening adjusting block from moving to the first end portion of the check link by coming in contact with the first portion; and
in a case where the movement restriction portion restricts the opening adjusting block from moving to the first end portion of the check link, the opening adjusting block restricts the check link from moving to the first end portion of the check link by having the second portion come in contact with the stopper portion.

15. An opening adjusting block adjusting an opening of a door for a vehicle, the opening adjusting device being used at a door checking mechanism including a door check configured to be fixed at the door for the vehicle, the opening adjusting block being provided with a check link including a first end portion being rotatably mounted on a vehicle body, the check link extending at an inside of the door for the vehicle, the check link being movable in a longitudinal direction of the check link relative to the movement restriction portion relatively, the opening adjusting block including a stopper portion being provided at a second end portion of the check link extending at the inside of the door for the vehicle, comprising
a recess configured to contain the check link, wherein
in a case where the opening adjusting block is disposed between the door check and the stopper portion so as to contain the check link at the recess, the opening adjusting block restricts the check link from moving to the first end portion of the check link by coming in contact with the door check and the stopper portion.
